(19) United States
(12) Patent Application Publication
(10) Pub. No.: US 2019/0082210 A1
(43) Pub. Date: Mar. 14, 2019

(54) ATOMIZING DIGITAL CONTENT INTO MULTI-MEDIA OBJECTS FOR TOUCHSCREEN AND HANDS-FREE MOBILE DEVICES

(71) Applicant: GADGET SOFTWARE, INC., Newark, NJ (US)

(72) Inventors: Patricia Alvarez, Union, NJ (US); Jessica Lozano, North Bergen, NJ (US); Maxwell K. Riggsbee, JR., Englewood, NJ (US); Michelle Sereno, Dover, NJ (US)

(21) Appl. No.: 16/128,849

(22) Filed: Sep. 12, 2018

Related U.S. Application Data
(60) Provisional application No. 62/557,874, filed on Sep. 13, 2017.

(51) Int. Cl. H04N 21/422; H04N 21/27; G06F 3/0488; H04N 21/23

(52) U.S. Cl. CPC H04N 21/42224; H04N 21/23; G06F 3/0488; H04N 21/27

(57) ABSTRACT

A method and system utilizing a new data element format that disaggregates the structure of content of a publication such as a Portable Document Format (pdf), eBook or webpage, i.e., dense digital content publication, into smaller units, e.g., words, images and media, where the disaggregated smaller units are then reanimated into adaptive thin object model records. The adaptive thin object model records include content and service elements that are then delivered to a user through a virtual publication delivery vehicle to a client system on a touchscreen or hands-free mobile device.

### CROSS-REFERENCE TO RELATED APPLICATIONS

This application claims priority of U.S. Provisional Patent Application Ser. No. 62/557,874, filed on Sep. 13, 2017, the subject matter of which is hereby incorporated by reference in its entirety.

### FIELD

This invention relates to the generation and manipulation of the structure of multi-media objects targeted for mobile communication devices.

### BACKGROUND

Historically, ideas have been arranged around the boundaries of physical paper, called books, therefore the content is arranged paragraph over paragraph, page by page. Following this sequential structure works for literature where the reader is inclined to follow the story linearly. Traditionally, books are constructed and present ideas in this linear fashion, also referred to as a linear reading path. A reading path is the way that the presented material determines or orders the way that a user reads the material. In a linear reading path the reader follows a prescribed arrangement of words. Moreover, in a linear reading path there is a sequential time to the text.

However, a significantly different kind of reading requires access to information (i.e., ideas) in a non-linear fashion. Reference oriented reading, where the reader needs to access or find information non-sequentially, has presented many challenges to the linear book structure. To minimize these challenges, electronic document publishing has included navigational mechanisms such as page numbers, table of contents, index pages and index tabs to help readers find the information they are looking for quickly. Those mechanisms were sufficient until readers began navigating websites where non-linear reading paths, non-linear records, or non-linear sequence of content typically occur. The website can present text and linked multi-media content that allows the reader to select the direction and path of what material to follow. Such user choices present a reading path that is non-linear and non-sequential.

Prior to 2007, digital reading primarily occurred within digital files portable document format (PDF) and electronic books (eBook) or webpages (browser) on desktop and laptop computers. PDF and eBook mimic the unimodal fixed reading path of printed text which means they inherited the navigation and presentation schemes associated with paper that are incompatible with touchscreen devices. Browsers re-orient webpages to align their display on a specific device. This frequently misaligns the content making it difficult to navigate lengthy information on multimodal touchscreen devices like smartphones which prefer to deliver previews connected to messages over sprawling pages of content.

The smartphone has achieved pride of place among the medium providing multimodal access to content. The dominance of smartphones in the new communication landscape requires a new content structure and delivery model that supports multimodal access of dense information found in reference manuals, textbooks, user guides, etc. Thus, at issue is how to transform this dense information into small, discoverable units that are updated, streamed and manipulated in real time.

### BRIEF SUMMARY

Given the foregoing, what is needed is a method and system with a new data element formatting for multimodal touch and hands free mobile devices that will restructure monolithic content originally developed for unimodal paper access and digitally presented in formats such as PDF on desktop and tablet devices. The disclosed new data element structure utilizes an atomic reading structure module that deconstructs, or atomizes dense information content and generates adaptive thin object model (“ATOM”) records that store data elements as a collection of multi-media objects. These ATOM records include unique attributes, data attributes, supplemental attributes and service attributes.

In an embodiment of the present disclosure, the atomizing system disaggregates the structure of content such as a PDF, eBook or webpage, i.e., dense digital content publication, into smaller units, e.g., words, images and media, where the disaggregated smaller units are then reanimated into adaptive thin object model records. The adaptive thin object model records include data elements, supplemental elements and service elements that are then delivered to a user through a virtual publication delivery vehicle to a client system on a mobile device.

In another embodiment of the present disclosure, the disaggregated content is stored in a server system as data elements where each data element represents a unit in a collection of adaptive thin object model records within the atomic reading structure modules. Each adaptive thin object model record includes data elements such as text, video, audio, etc., supplemental elements such as price, calendar, maps and data feeds, and service elements such as real-time locations, notifications, data feeds, etc., which are dynamically added, updated or removed from an atomic reading structure module, wherein the atomic reading structure module manages the collection of adaptive thin object model records.

In another embodiment of the present disclosure, an authoring console receives a template from the atomic reading structure module that defines a first structure for a structured content and a second structure for an unstructured content. The template is configured to determine the data element and associated service elements available to a first adaptive thin object model record. Further, the first adaptive thin object model record can be linked to a second adaptive thin object model record within a virtual publication, wherein each adaptive thin object model record has a unique identifier. The adaptive thin object model records are also configured to allow an author to add service elements to an adaptive thin object model record, whether an adaptive thin object model record is in a hidden or visible state. A particular sequence can be generated to define a serialized reading path of the adaptive thin object model records.

Further features and advantages of the present disclosure, as well as the structure and operation of various embodiments of the present disclosure, are described in detail below with reference to the accompanying drawings. It is noted that the present disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the present invention and to enable a person skilled in the relevant art(s) to make and use the present invention.

Additionally, the left-most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which are the same in structure, operation, or form but may be identified as being in different locations in space or recurring at different points in time (e.g., reference numbers ‘110a’ and ‘110b’ may indicate two different energy detection devices which are functionally the same, but are located at different points in a simulation arena).

FIG. 1 is a system diagram depicting an implementation of a system for atomizing digital content into multi-media objects in communication with a mobile device, according to an embodiment of the present disclosure.

FIG. 2 depicts a set of operations to transform dense content by extracting, and importing data elements and delivering as adaptive thin object model records to a mobile device, according to an embodiment of the present disclosure.

FIGS. 3A and 3B illustrate a linear and non-linear reading path, according to an embodiment of the present disclosure.

FIG. 4 depicts the components of a system for atomizing digital content into data elements and the delivery of adaptive thin object model records to a LiveClient application, according to an embodiment of the present disclosure.

FIG. 5 illustrates disaggregating, by the use of a server, a PDF document, eBook and website, according to an embodiment of the present disclosure.

FIG. 6 illustrates the use of a template to apply to the data elements in the generation of adaptive thin object model records, according to an embodiment of the present disclosure.

FIGS. 7A, 7B and 7C depict a configuration settings screen to generate and upload data elements, according to an embodiment of the present disclosure.

FIG. 8 illustrates a configuration screen with a list of predetermined categories associated with particular data elements to produce adaptive thin object model records, according to an embodiment of the present disclosure.

FIG. 9 depicts an atomic reading structure module configuration screen with multiple adaptive thin object model records and the records as delivered to a mobile device, according to an embodiment of the present disclosure.

FIGS. 10A, 10B, 10C, 10D, 10E, 10F, 10G, 10H and 10I illustrate an editing mode of an authoring tool and screen shots of authoring consoles and editing tools used with an adaptive thin object model record, according to an embodiment of the present disclosure.

FIG. 11 illustrates delivery of adaptive thin object model records through a client to a mobile device, according to an embodiment of the present disclosure.

FIGS. 12A and 12B depict a focus mode of a selected adaptive thin object model records and playlists, according to an embodiment of the present disclosure.

FIG. 13 depicts the use of a notification service with a unit of text delivered to a mobile device, according to an embodiment of the present disclosure.

FIG. 14 is a flow chart of a method to generate an adaptive thin object model record, according to an embodiment of the present disclosure.

FIG. 15 illustrates an example computer implementation, according to an embodiment of the present disclosure.

Further embodiments, features, and advantages of the present invention, as well as the operation of the various embodiments of the present invention, are described below with reference to the accompanying figures.

### DETAILED DESCRIPTION OF THE INVENTION

While embodiments described herein are illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, it is understood that it is within the knowledge of one skilled in the art to affect such feature, structure, or characteristic in connection with other embodiments whether or not explicitly described.

The atomizing system includes multiple types of technology and includes a LiveClient application, a library component, a virtual channel component, a virtual publication component, an atomic reading structure module component, and an adaptive thin object model record. The LiveClient application is an access control scheme developed to segment virtual publications (“vPub containers”). The LiveClient application can access a virtual publication and then segment the content by library and further categorize by virtual channels (topics, subjects or themes). Virtual channels are dynamically created, or deleted, within a library. Once a virtual channel is created, channel managers add vPub containers to that channel. Virtual publications can be assigned to multiple channels. A LiveClient application aggregates multiple virtual libraries and can stream content from any vPub container within any virtual channel.

The LiveClient application is also a virtual publication reader that is downloaded to a device such as a mobile device, and aggregates virtual libraries consisting of virtual channels and virtual publications. The virtual publication is a digital entity comprised of multiple content module types that are published dynamically over a data network to the LiveClient application. The atomic reading structure is a specialized content module housed within the virtual publication that manages a collection of adaptive thin object model records and defines the data elements and service elements available to the adaptive thin object model records. It also enables the organization and determines the functionality available to the LiveClient application. And, the adaptive thin object model record is a uniquely identifiable self-describing digital object manipulating a sliver of metadata, multimedia data, data feeds and geo-tagged information where each represents a unit of a digital document. The objects use data elements and service elements provided by the atomic reading structure to store content and access services.

### Technological Problem

At present, the technologies (PDF, eBook and webpage—dense digital content publications) used to present dense content found in reference manuals, textbooks, user guides are optimized for paper and browsers, but not specifically for touchscreen and hands-free mobile devices. Therefore, the user's ability to navigate content organized for touch and hands-free semantics does not exist.

PDF readers are designed to display text and images relative to a unimodal access scheme based on physical page layout. Further, the fixed file format cannot be updated dynamically nor can it integrate with mobile device-specific technologies such as cameras, geo-locations or notifications. Neither PDF files nor the readers that interpret them are capable of multimodal access schemes encouraged by touchscreen and hands-free interface mobile technology. Finally, since PDF technology mimics physical page structure it cannot fragment documents into units of information that would enable the reader to consume specific units.

eBook or ePub readers, like PDF, are aligned to a physical page structure and unimodal access scheme. Their file based approach is not designed to take advantage of mobile device-specific technologies and therefore also cannot integrate camera, geo-location or notifications. At best such readers display text, images and potentially multi-media based on a responsive layout. In addition, their file formats are fixed and cannot be updated dynamically.

Web browsers, like eBook readers, can display content responsively based on screen type. However, hypertext markup language (HTML) follows the unimodal flow of paper and restricts the reader's ability to toggle between linear and non-linear engagement on touchscreen devices. Further, the lack of an object model makes it difficult to organize content into units that can be independently consumed and manipulated by the reader.

### Technological Solution

The present disclosure utilizes a virtual publication approach including the creation of a collection of specialized content modules comprising data elements where each represents a unit of the digital document, which are streamed and read by a client within a mobile device. The client reanimates data elements as a collection of adaptive thin object model records. Each adaptive thin object model record represents a unit of a digital document. Each adaptive thin object model record can be edited independently and contains unique identifiers, extensible data elements and service elements. The adaptive thin object model records are ordered, associated with multiple groups, searched, linked and saved. Further, the adaptive thin object model records are arranged to facilitate linear reading via swipe touch semantics while enabling user-defined nonlinear reading experiences via search, select touch semantics and user-defined groupings (playlists). In addition, each adaptive thin object model record is read by the client as a message stream whereas PDF and ePub load files oriented around paper, and browser based readers responsively re-orient content based on display dimensions. None of these conventional technologies specifically organize the content to fully utilize touchscreen and hands-free semantics, making it difficult to navigate and search on touchscreen and hands-free mobile devices.

The current solution utilizes a unique architecture integrating content authoring and content consumption. The content authoring includes an authoring console where:
an atomic reading structure module provides templates that are specialized for structured content, e.g., step-by-step procedures, and unstructured content, such as reference manuals;
the atomic reading structure module template determines the data elements and service elements available to adaptive thin object model records;
each adaptive thin object model record has a unique identifier and can be linked from other adaptive thin object model records within or across virtual publications; further, authors can add and select data elements to edit;
authors can add service elements to adaptive thin object model records;
authors can determine whether an adaptive thin object model record is in a hidden/visible state;
authors can determine whether an adaptive thin object model record can be added and saved to a playlist;
authors use atomic reading structure module sorting to sequence adaptive thin object model records and define a serialized reading path;
authors can determine whether changes to adaptive thin object model records are tracked and journaled; and
authors can determine whether adaptive thin object model records can be navigated from one to another via swipe.

The content consumption includes a LiveClient application in a mobile device where:
the atomic reading structure module presents an organized list of adaptive thin object model records to a virtual publication component that streams to the LiveClient application;
in flash mode, the adaptive thin object model records are presented within lists for quick viewing, search and selection, which includes a list view where each adaptive thin object model record can present an icon, title and summary for quick reading;
in focus mode, the adaptive thin object model record is selected and the data element details are presented to the reader along with supplemental elements e.g., a schedule, contact information, data feed, map etc., where users move from adaptive thin object model record to adaptive thin object model record by swiping the screen or selecting next/previous options;
users can save adaptive thin object model records to personal playlists; and
adaptive thin object model records with notification service elements deliver summarized information to users as notifications based on time or location.

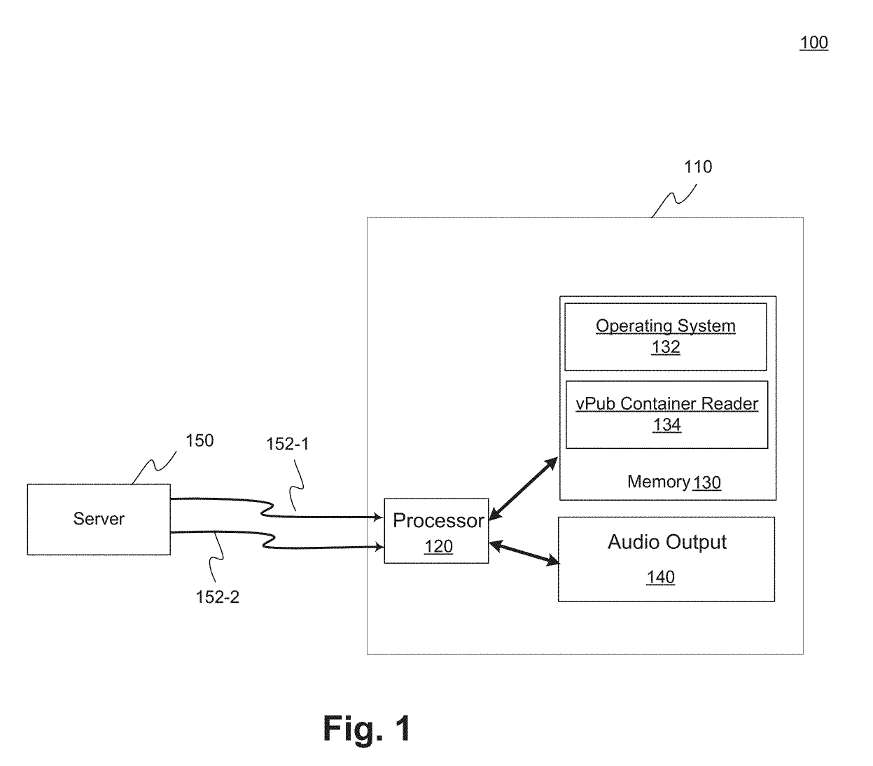

FIG. 1 illustrates an atomizing system 100, according to an embodiment. Atomizing system 100 includes a mobile device 110, where mobile device 110 also includes a processor 120, a memory 130 that contains an operating system 132 and a virtual publications (“vPub container”) reader 134. Atomizing system 100 also includes an audio output 140 and communications to allow for multiple libraries and channels 152, labeled 152-1 and 152-2, to server 150. Atomizing system 100 is also referred to and known as an adaptive thin object model system. Mobile device 110 can be any type of smartphone, tablet, eyeware, or bodyware device that includes a touch or hands-free interface.

In an embodiment, server 150 maintains the virtual publication content such as pdf documents, eBooks and/or webpages. Server 150 is configured to perform the three types of operations needed to deliver content to mobile device 110. These operations include the extraction and disaggregation of information from a virtual document, the importing of the extracted disaggregated information, the generation of an adaptive thin object model record and the delivery of that adaptive object model to mobile device 110. These are also referred to and known as an extraction system or a disaggregation system, an importing system and a delivery system.

The atomizing system disaggregates the structure of content such as Portable Document Format (pdf), electronic book (eBook) or webpage into smaller units representing ideas and concepts consisting of words, images and media. To extract ideas from documents, the atomizing system converts PDF or ePub to HTML. The atomizing system removes document structure such as inline styles, classes and IDs, comments and metadata unrelated to visible text and media, thus leaving only data content. The atomizing system analyzes the remaining text and styling elements, e.g., data content, to identify unit boundaries that make up an idea block. The atomizing system inserts unit markers above each idea block. For each unit marker, the atomizing system extracts the idea block and saves each unit as a data element file. The atomizing system ingests each data element file, and adds title, summary, sort value and additional identifying attributes to the data element text. The atomizing system concatenates each data element file as a row in a data element worksheet or section in a data element extensible markup language (XML) file. The process is shown in the table below.

TABLE 1
Disaggregating Idea Blocks from Document

Step 1: Convert PDF or ePub to HTML
Step 2: Remove inline styles, classes and IDs, comments and any
metadata unrelated to visible text and media
Step 3: Insert unit markers above each idea block
Step 4: For each unit marker extract the idea block and save each as a
data element file
Step 5: Ingest each data element file, add title, add summary, sorting
value and additional identifying attributes to the data element file
Step 6: Concatenate each data element file as a row in a data element
worksheet or section in a data element XML file.

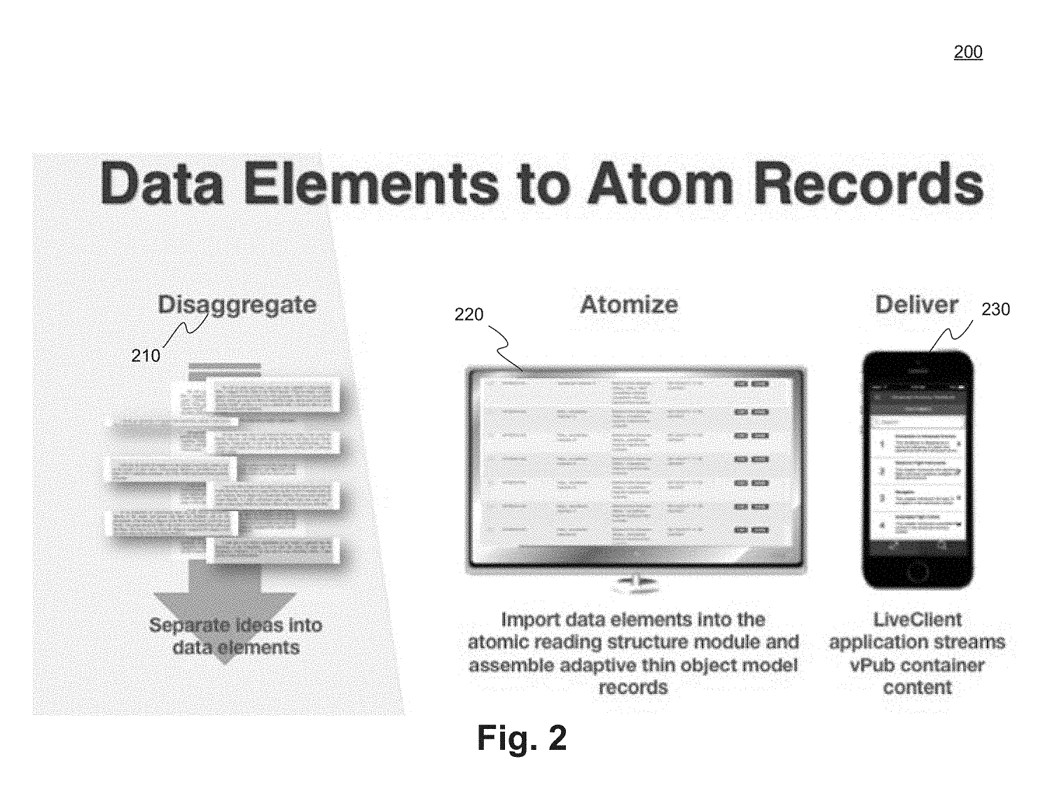

FIG. 2 illustrates an atomization system flow 200 that includes the set of operations required to extract and transform dense content information from a virtual publication and deliver an adaptive thin object model record to client software on a mobile device, according to an embodiment. Atomization system flow 200 consists primarily of three operations, disaggregate 210, atomize 220 and deliver 230.

Disaggregate 210 includes the reading, or receiving, of a document and the subsequent extraction of that document's content. The extraction includes the identification and separation of different types of content within the document. The content typically would include items such as text, images, keywords and summaries. Disaggregate 210 results in a collection of identified various forms of data elements, i.e., identified data elements, into a file. Atomize 220 includes the uploading of the file of separated data elements into the atomic reading structure module in which each identified data element is assembled and stored as an adaptive thin object model record, i.e., stored adaptive thin object model records. Deliver 230 includes the process of receiving a request from a user on a mobile device via a LiveClient application executing on the mobile device in which the client loads a requested virtual publication to view one or more adaptive thin object model records.

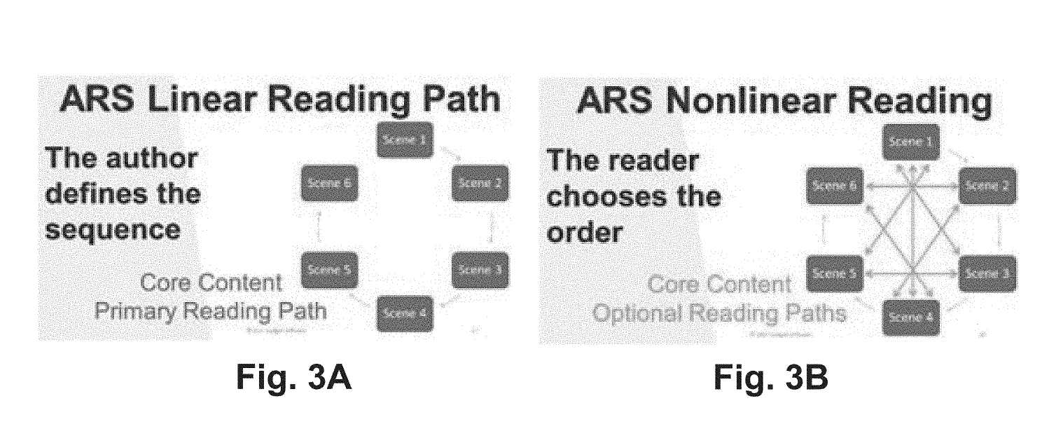

FIGS. 3A and 3B illustrate examples of reading paths, according to an embodiment. Typical books or documents are constructed and presented as shown in FIG. 3A where the author defines the sequence of reading in that pages contain sequential paragraphs, chapters, or sections. However, as shown in FIG. 3B a nonlinear reading path allows the user, or reader, to select the sequence of content to be viewed. In a nonlinear reading path the user, rather than the author, selects the sequence of content to be viewed.

The atomic reading structure module increases content density, provides greater context and simplifies readability by adding data elements and service elements, e.g., mapping and notification, per adaptive thin object model record. It also improves search discoverability and usability by listing the title, summary and icon of the adaptive thin object model records that contain the requested information.

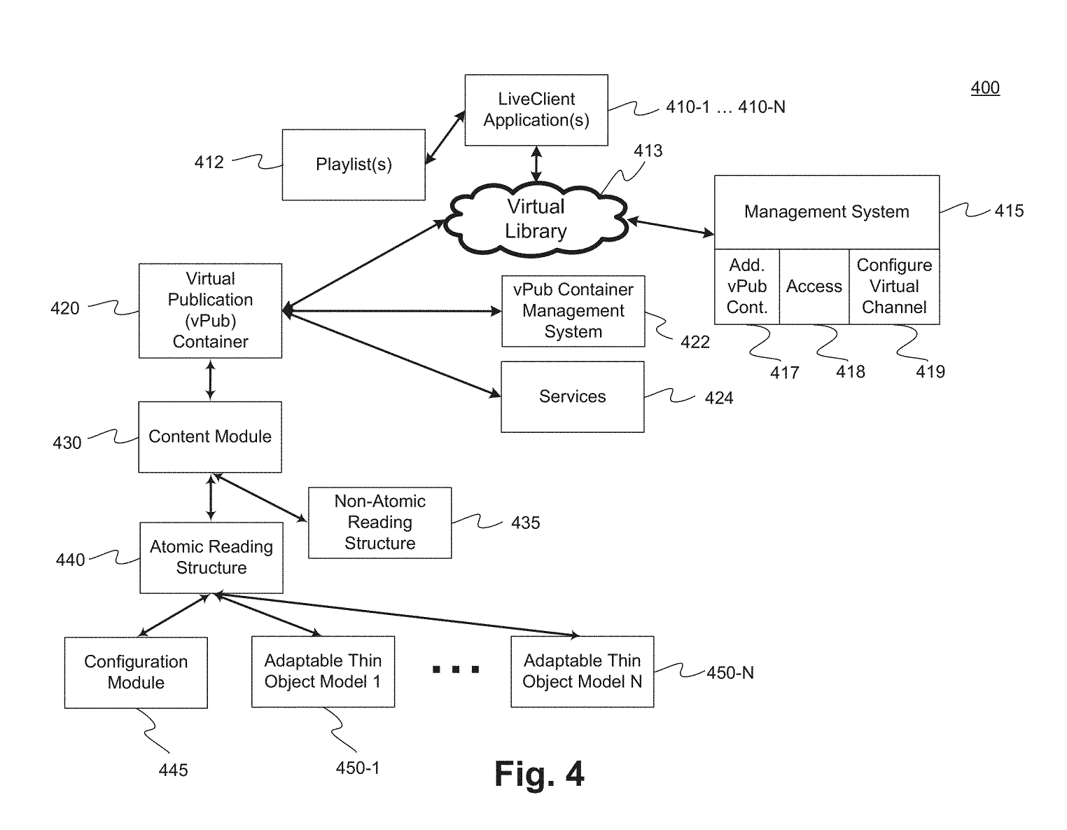

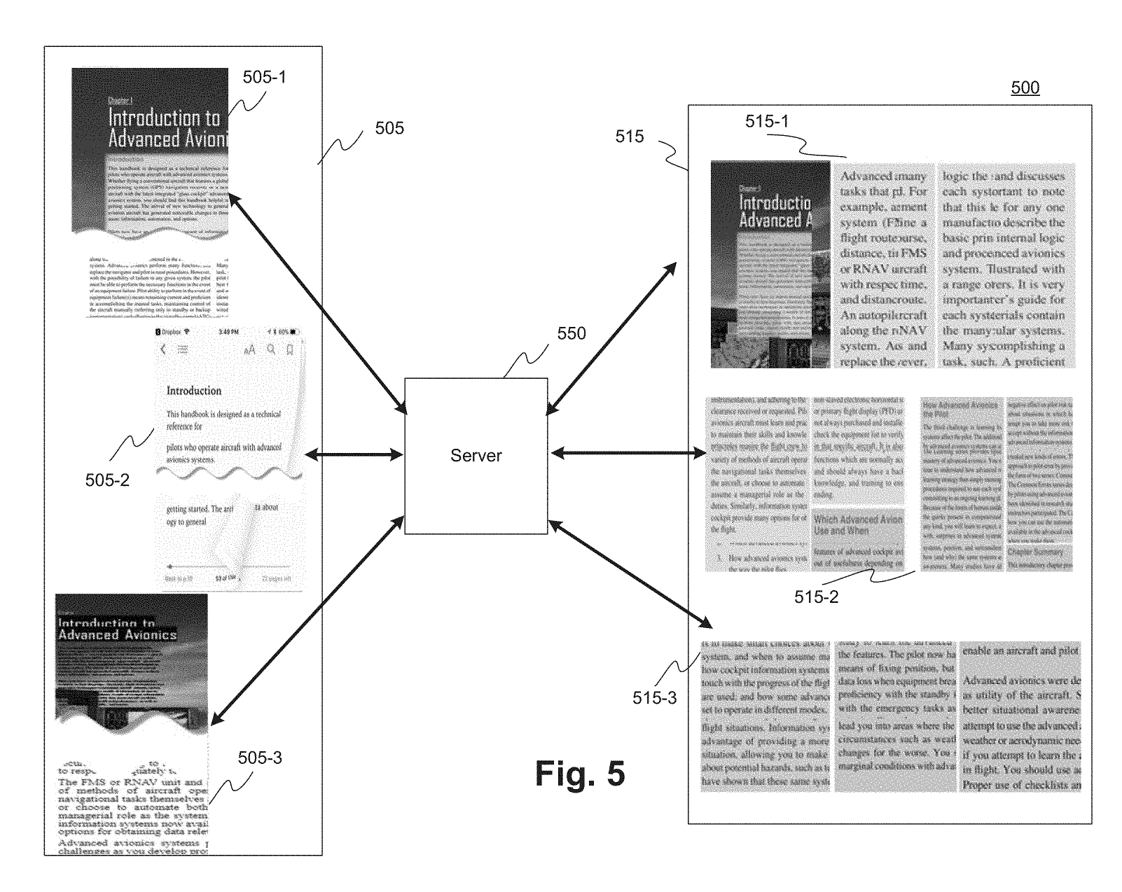

FIG. 4 depicts a system 400 that includes components for atomizing digital content into data elements and the delivery of adaptive thin object model records to a LiveClient application, according to an embodiment of the present disclosure. System 400 includes multiple LiveClient applications 410-1 to 410-N, a playlist 412, a virtual library 413 containing virtual channels, a management system 415 that includes an additional vPub container 417, an access control module 418 and a configure virtual channel module 419. System 400 also includes a “Virtual Publication” vPub container 420, content modules 430, a non-atomic reading structure module 435, an atomic reading structure module 440, a configuration module 445, and a first adaptive thin object model record (450-1) through adaptive thin object model record N (450-N). In an embodiment, there can be any number of LiveClient applications and playlists.

LiveClient application 410-1 typically resides on a mobile device, which can include any type of wireless mobile device including a tablet, smartphone or a wearable device including a head mounted display or smart glasses. LiveClient applications 410-1 to 410-N is configured to allow a user to view a virtual publication that is streamed to the wireless mobile device and aggregates multiple virtual libraries and virtual channels. In an embodiment, multiple mobile devices exist where each mobile device is associated with a different LiveClient application, e.g., LiveClient application 410-1, 410-2 . . . 410-N. Virtual library 413 is created that includes multiple virtual channels. Multiple virtual libraries can be created where each virtual library and its virtual channels are dynamically created, or eliminated, as necessary. Once created a virtual library is assigned to a particular LiveClient application. Each LiveClient application 410-1 through 410-N polls an active virtual library 413, its virtual channels, and vPub containers 420, either on a periodic basis or on demand, to determine if content, security or structural characteristics of the content have been updated. Any detected content change is applied and presented to the appropriate LiveClient application 410-1 to 410-N and thus presented to one or more users. When the vPub container contains an active content module, the user can stream audio, video or text across the virtual channel and into the LiveClient application where it can be viewed or stored for later retrieval

Virtual library 413 contains virtual channels that provide the communication pathway between the user and LiveClient application(s) 410-1 through 410-N with the other components of system 400. Virtual library 413 can include virtual channels that are bi-directional to deliver virtual publication content and also allow management system 415 to configure and control the use of the virtual channels. Virtual library 413 can include multiple virtual channels where each virtual library is dynamically created and assigned to a LiveClient application 410-1 to 410-N. Once a virtual library 413 is created it is managed by management system 415.

Management system 415 allows for the control of access and content transfer through virtual library 413. For example, the sub-section labeled as additional vPub container 417 controls which virtual publications are allowed to be viewed by LiveClient applications 410-1 to 410-N. Similarly, access control module 418 controls which users have access to which virtual publications. Configure virtual channel module 419 controls and dynamically creates and presents those virtual channels through virtual libraries to LiveClient applications 410-1 through 410-N. Once a virtual channel is created, configure virtual channel module 419 assigns vPub containers to that channel. In addition, LiveClient applications 410-1 to 410-N can aggregate multiple virtual libraries which contain virtual channels and can stream content from any vPub container assigned to a particular virtual channel.

Virtual library 413 operates in two states, where each state is either enabled or disabled, and also allows for public or private access restrictions. When a particular virtual library 413 is private, or disabled, that virtual library is unavailable to LiveClient applications 410-1 to 410-N along with their virtual channels and associated vPub containers, even if the virtual channel is visible and the vPub container is published. Public virtual libraries are visible within LiveClient applications 410-1 to 410-N and can display all of the visible virtual channels. Private virtual libraries are not displayed in LiveClient application 410, however its public virtual channels and published vPub containers are accessible via a specialized code. vPub containers can be assigned to multiple virtual channels within a virtual library. Users can also select a particular vPub container as a favorite allowing for quick and easy access across multiple virtual channels.

vPub container 420 is a digital entity that controls the dynamic publishing of content that is delivered through one or more virtual library 413, where each virtual library 413 contains multiple virtual channels to LiveClient applications 410-1 to 410-N. vPub container 420 is managed by vPub container management system 422 and interacts with services module 424. vPub container management system 422 controls the look and feel of a particular virtual publication and any associated settings such as a look and feel, content module management, authoring-user access control and mobile-user access control. Further, vPub container management system 422 is capable of analyzing user statistics and controls attributes of each virtual publication such as access, additional content modules, configuration settings, edit settings, organization, and storage requirements.

vPub container 420 represents the concept of streaming content by the assembly, publishing and delivery of publication content on demand. In this case the publication content includes data and content object types where every object can be described with metadata. vPub container 420 also allows for objects to be dynamically added, removed or replaced.

Services module 424 is designed to provide access to the virtual publication for services such as data feeds, data queries, media, location, and notifications. Data feeds include real-time information from sensors or similar devices. Data queries retrieve information from customer data sources. Media services include such media as video, audio and any other images. Location services include geo-centric services such as proximity to an associated location in the virtual publication, or mapping services and Global Positioning System coordinates associated with a location. Notification services would include the ability to alert a user with particular content based on time or location.

Content module 430 stores and supplies the content contained in a virtual publication and is controlled and configured by vPub container 420. Content module 430 accepts content from non-atomic reading structure module 435 and atomic reading structure module 440. Non-atomic reading structure module 435 represents additional content structures such as Contact Directory, Form, Calendar, Map, etc. In contrast, atomic reading structure module 440 contains disaggregated pages of linear content converted into data elements and stored as a collection of adaptive thin object model records. Atomic reading structure module 440 is responsible for content creation and authoring in addition to content consumption, or the supplying of content to vPub container 420. Atomic reading structure module 440 also contains a variety of templates that define the structure of a type of virtual publication. For example, atomic reading structure module 440 would contain a template for a typical reference manual and another template for procedural steps. Any number of templates can be defined for any particular structure of content and used by atomic reading structure module 440 to determine the data elements, supplemental elements and service elements available to adaptive thin object model records 450.

Configuration module 445 controls the configuration settings associated with atomic reading structure module 440. These settings include services and content, the sort order, the ability to swipe content, the ability to playlist content, e.g., playlist 412, the ability to journal changes, the ability to backup ATOM records, state of the reading structure module (visible, hidden or offline), organizing services (categories and topics), content attribute settings for the particle settings (contact, description, image, price, tags, schedule, section, and summary), etc.

Atomic reading structure module 440 contains one or more adaptive thin object model records, which are labeled as 450-1 through 450-N. Each adaptive thin object model record 450-1 to 450-N is an object that represents a unit of a larger publication and contains unique identifiers. The objects use templates and service elements provided by atomic reading structure module 440 to store content and access services. Each adaptive thin object model record 450-1 to 450-N manages a unit of the total content of a virtual publication and includes data elements, e.g., text, video, audio, etc., and service elements, e.g., locations, notification, etc., that can be added, updated or removed from atomic reading structure module 440 dynamically. The adaptive thin object model records 450-1 to 450-N are streamed through vPub container 420 through a virtual library 413 that contains virtual channels to LiveClient applications 410-1 to 410-N. Further, each adaptive thin object model record 450-1 to 450-N can be edited independently and can be ordered and associated with multiple groups, searched, linked and saved.

FIG. 5 illustrates a system 500 in the process of disaggregating dense content, by the use of a server, according to an embodiment. System 500 includes dense content 505, a server 550 and the disaggregated data elements 515. Dense content 505 is shown with examples of a pdf document 505-1, an eBook publication 505-2 and a website 505-3. Dense content 505 is received by server 550 and then server 550 uses a predefined template based on the type of dense content to generate the disaggregated data elements 515-1 from pdf document 505-1, disaggregated data elements 515-2 from eBook publication 505-2, and disaggregated data elements 515-3 from website 505-3. Note the different highlighting in the disaggregated data elements 515 to illustrate the different identified units of each content.

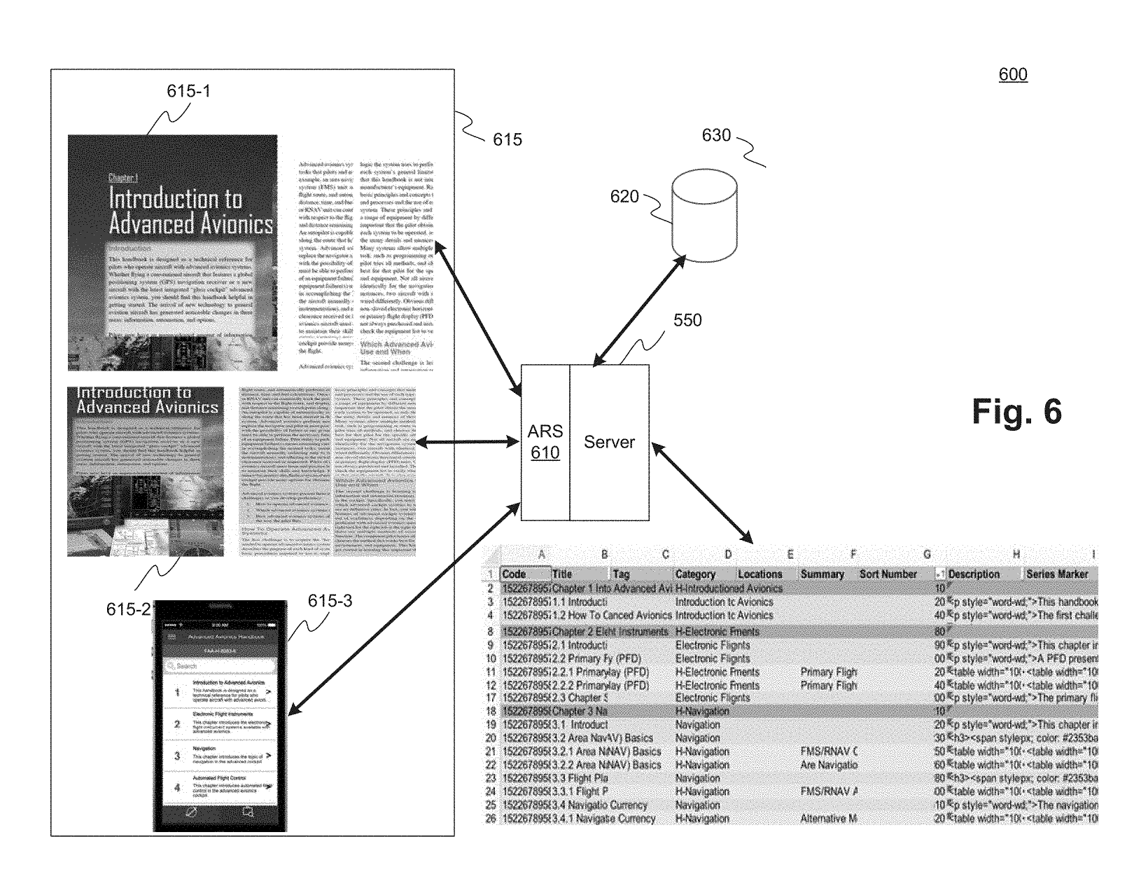

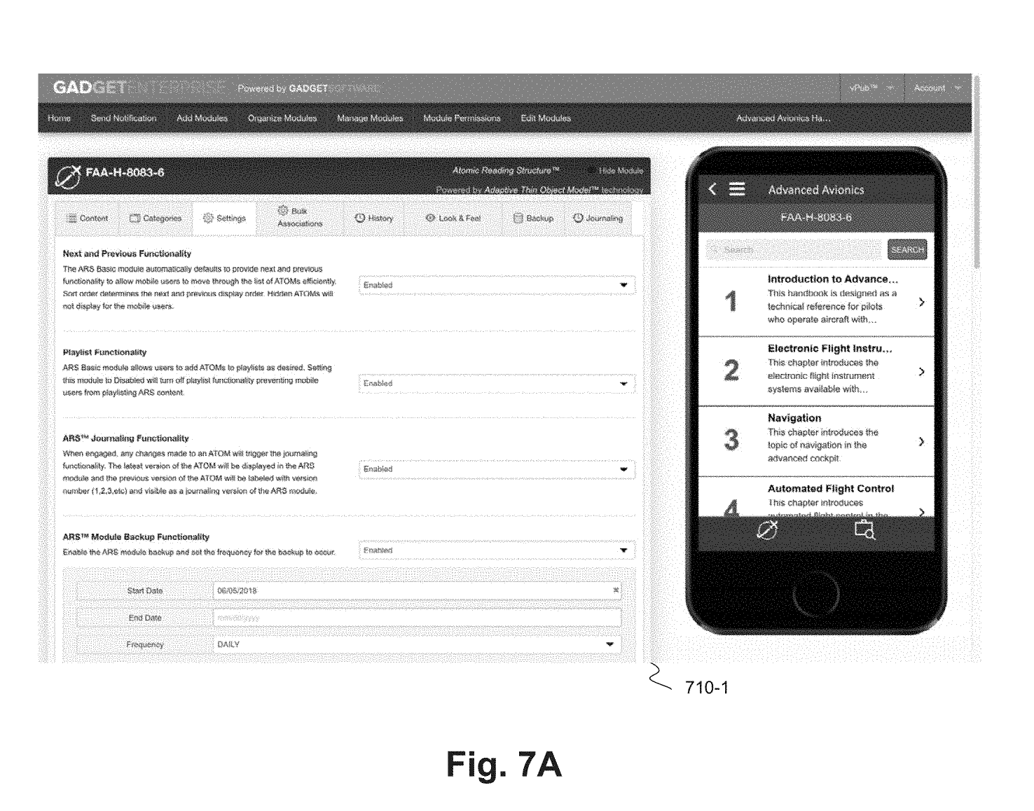

FIG. 6 illustrates a system 600 with the use of a data element template to disaggregate in the generation of adaptive thin object model records, according to an embodiment. System 600 includes server 550 with atomic reading structure module 610 and storage system 620, and upload data element worksheet 630. Disaggregated data elements 615 are generated by server 550 and atomic reading structure module 610 through the application of a template. In an embodiment, a template is applied to the chapters, sections and sub-sections of the text organized across each page represented in a pdf, eBook or HTML webpage. In an example case each adaptive thin object model record contains multi-media data (description), first 145 characters (summary), assigned object label (title), ordering value (sort number, title, date created or custom), and group assignment (category or category assignment) that is extracted, or disaggregated, into data elements from the dense content and stored in a formatted spreadsheet or XML document. The template does not have to have all of the characteristics listed here, or may have additional criteria, but are merely listed as examples. The atomic reading structure (ARS) module 610 template and service elements are configured prior to the storage of the content. Configuring the template determines which elements are available to all adaptive thin object model records, such as “Next/Previous” swipe functionality. Further, the template can also control whether a particular element is operating in a required, optional, or off mode. Note that data element worksheet 630 shows, for each row (adaptive thin object model record), an associated sort number, category, title, summary, text and description.

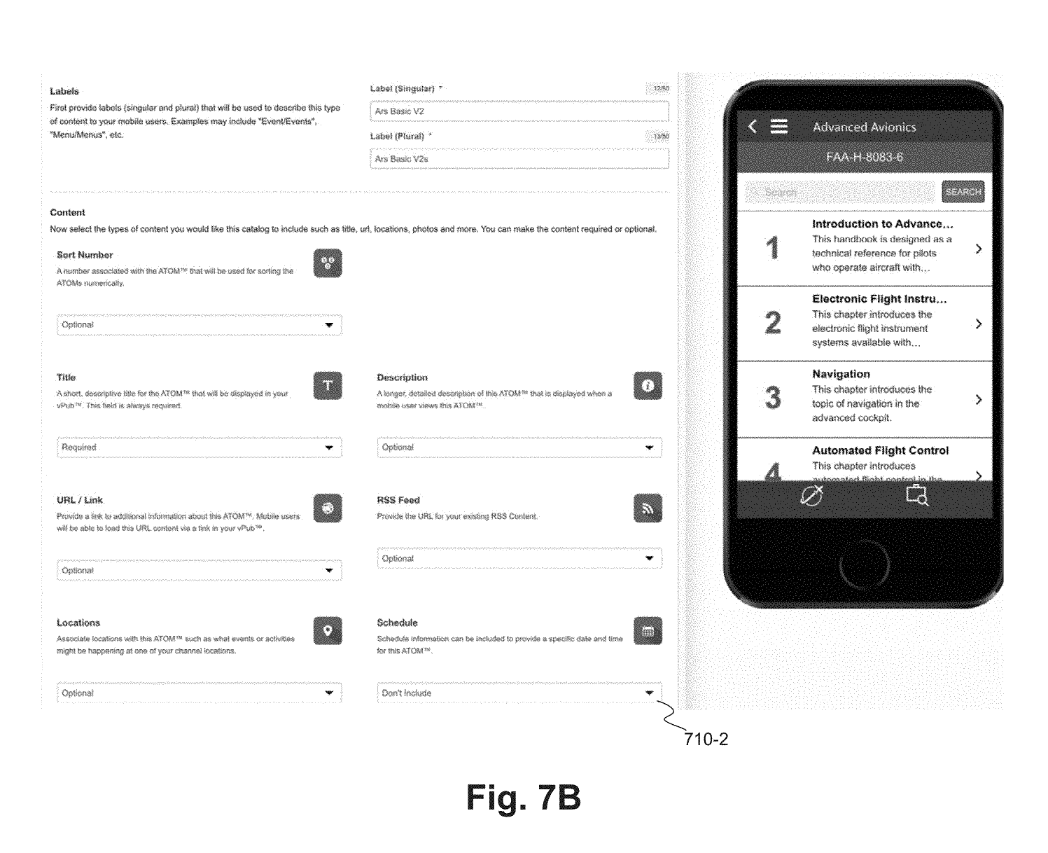

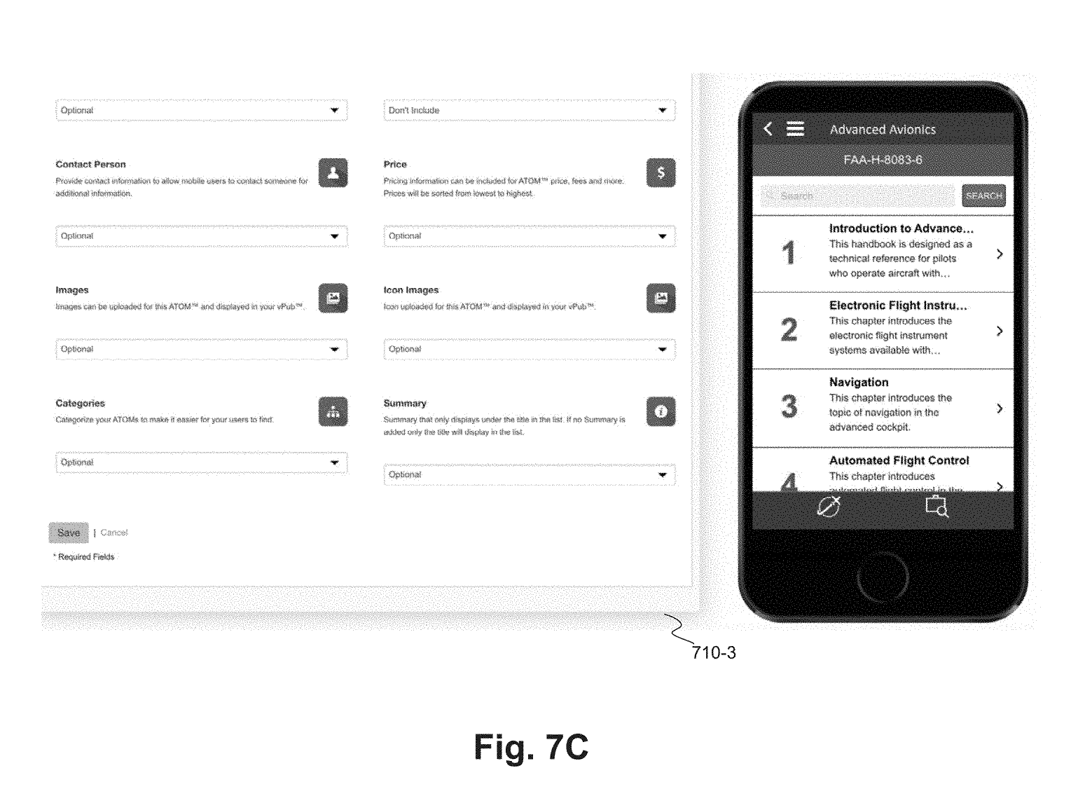

FIGS. 7A, 7B and 7C depict a configuration setting screen to direct and upload the data elements according to an embodiment. The top one-third of the configuration screen is shown as configuration screen 710-1 in FIG. 7A and the middle-third is shown as configuration screen 710-2 in FIG. 7B with the lower-third shown as configuration screen 710-3 in FIG. 7C. The configuration screen defines, for each adaptive thin object model record, if certain sources of information are required, optional or turned off. In this example, the fields include a sort number, title, description, URL/Link, RSS feed, locations, schedule, contact person, price, images, categories and summary. This list of fields is merely as an example and is not meant to be limiting. Once the configuration screen 710 (710-1, 710-2 and 710-3) is complete, the file containing the data elements can be uploaded.

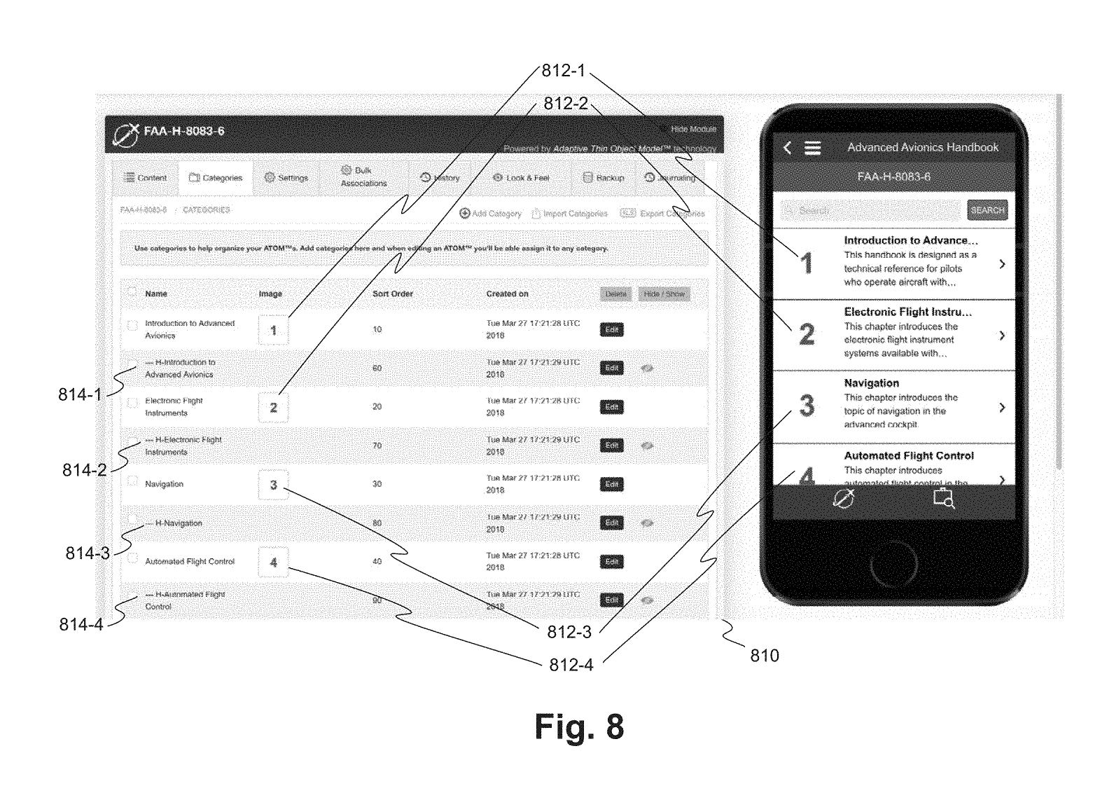

FIG. 8 depicts a configuration screen with a list of predetermined categories that can be associated with an adaptive thin object model record, according to an embodiment. Configuration screen 810 illustrates an example of eight different predetermined categories, some with an associated image. Each category shows a sort order and can have a state of visible or hidden. In this example, the system calculates and displays that there are 4 visible (812-1 to 4) and 4 hidden categories (814-1 to 4).

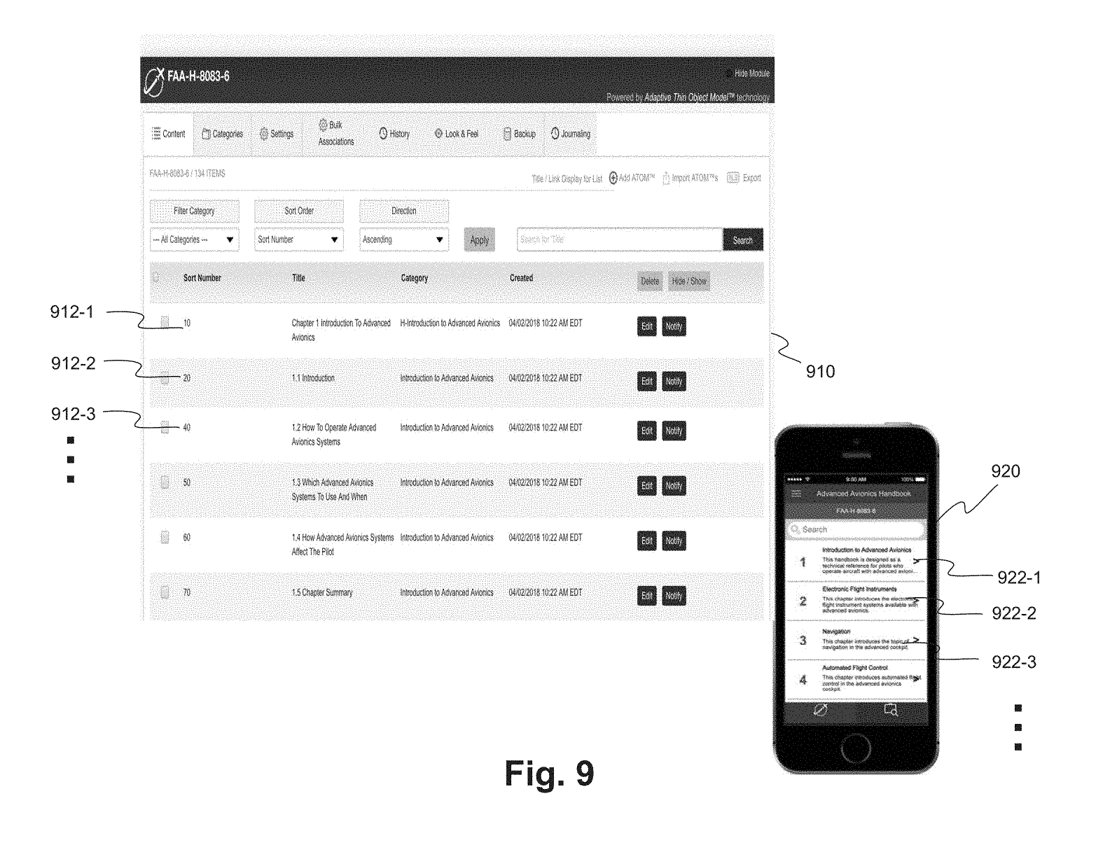

FIG. 9 depicts a content configuration screen with multiple adaptive thin object model records that are delivered to a mobile device, according to an embodiment. Content configuration screen 910 shows multiple adaptive thin object model records 912-1 to 912-3. Mobile device 920 illustrates received and displayed adaptive thin object model records 922-1 to 922-3. The system calculates and displays that the completed upload will produce 134 adaptive thin object model records.

Each adaptive thin object model record 912-1 to 912-3 represents a unit of content consisting of sections, sub-sections or similarly associated text extracted from the document plus the title, summary, sort number, assigned categories and unique identifier. Each adaptive thin object model record 912-1 to 912-3 contains more content than the original unit making the aggregate size of the adaptive thin object model record 912-1 to 912-3 larger than the original publication. If hidden, adaptive thin object model record 912-1 to 912-3 is not selectable, or searchable, however it remains linkable. Adaptive thin object model record 912-1 to 912-3 is comprised of a unique system generated identifier, data element and service elements. Attaching supplemental elements and service elements to an adaptive thin object model record 912-1 to 912-3 increases its multimedia density where data element content is stored and managed within each adaptive thin object model record 912-1 to 912-3.

Service elements connect adaptive thin object model record 912-1 to 912-3 to external resources provided by vPub container 420, LiveClient applications 410-1 to 410-N, internet or extranet service. Such an internet service can include access to a web page, RSS feed, iCal feed or any other internet based information source. Such an extranet service can include authorized access to corporate data sources, feeds from sensors or other services. Further, when adaptive thin object model record 912-1 to 912-3 or 922-1 to 922-3 connects to atomic reading structure module 440 it can associate with a different group (category). Or, when adaptive thin object model record 912-1 to 912-3 or 922-1 to 922-3 connects to a web service, it can access an external site. Also, when adaptive thin object model record 912-1 to 912-3 or 922-1 to 922-3 connects to vPub container 420, using a location or notification service, LiveClient applications 410-1 to 410-N can be used to present real-time maps and receive notifications from the adaptive thin object model record 912-1 to 912-3 or 922-1 to 922-3 based on location, time or date.

Adaptive thin object model record 450-1 to 450-N, or any of the other referenced adaptive thin object model records, operates in one of two states, visible or hidden. Hidden adaptive thin object model records are excluded from lists and serialized reading progression. However, such hidden adaptive thin object model records are linkable. Atomic reading structure module 440 can sort adaptive thin object model records based on Sort Number, Title, Date or user defined arrangement. Sorting determines the order the adaptive thin object model records 450-1 to 450-N are presented for console editing. It also determines the order of adaptive thin object model records will be viewed and accessed within LiveClient applications 410-1 to 410-N.

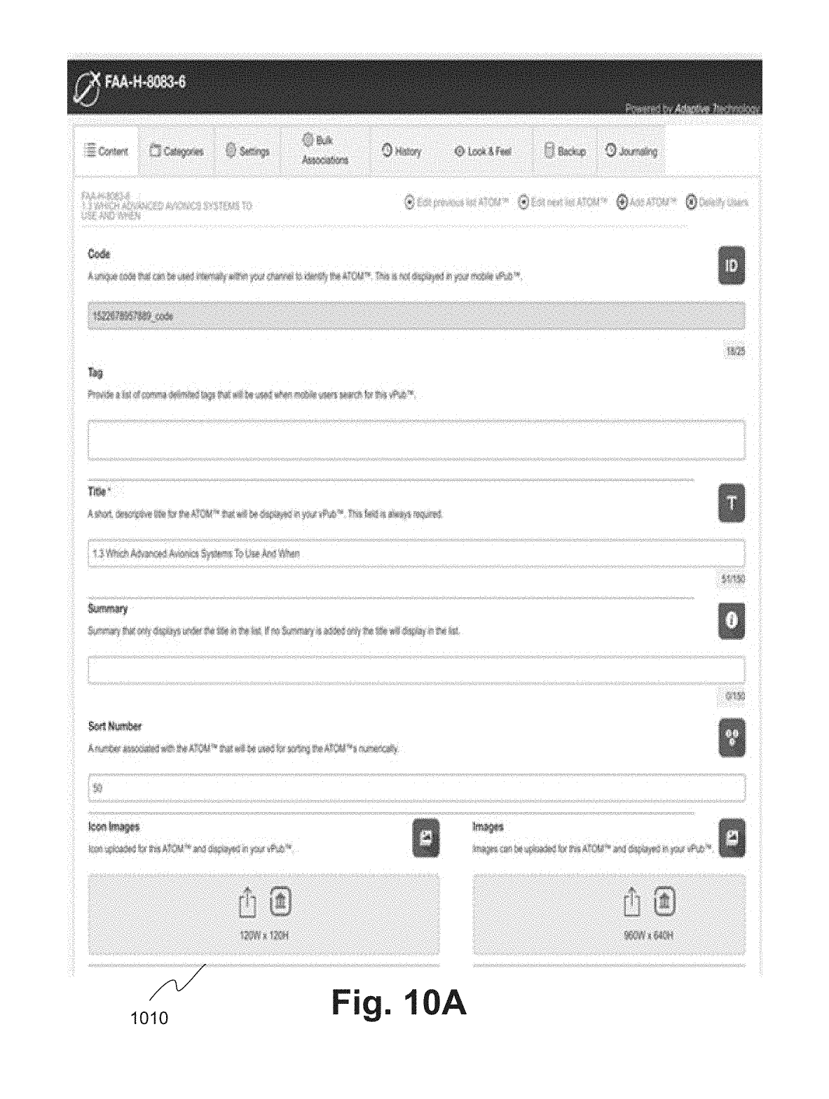

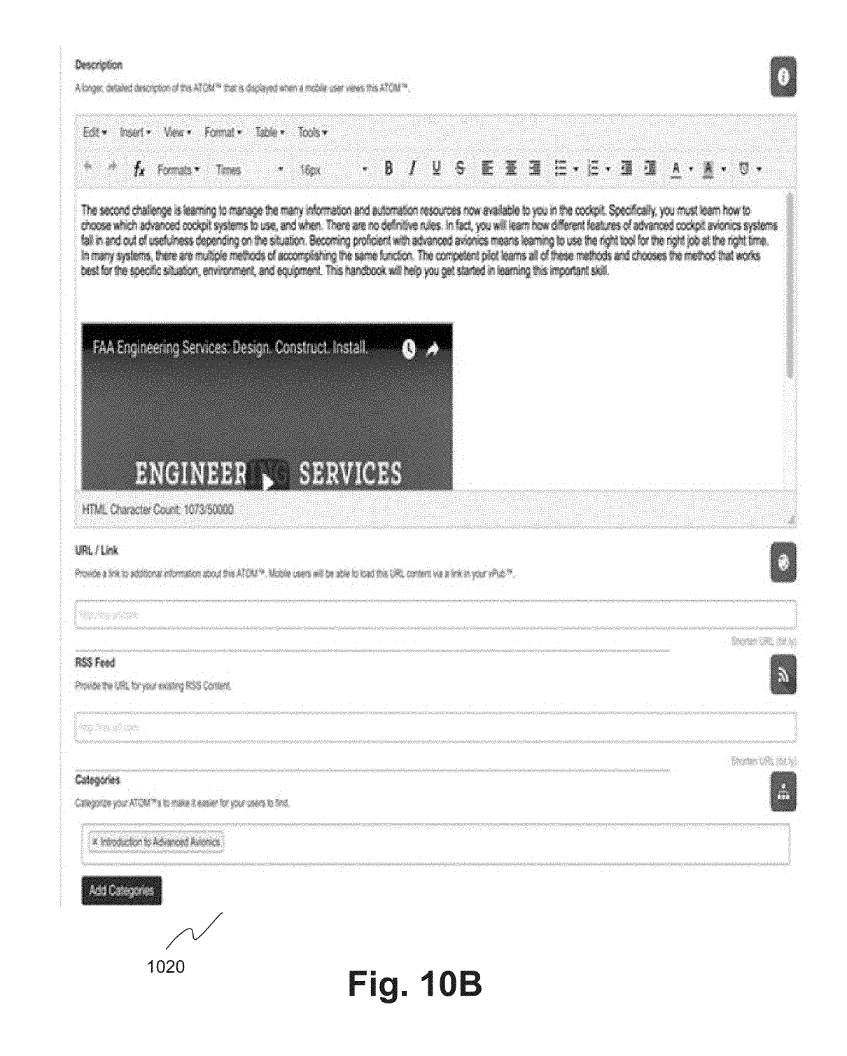

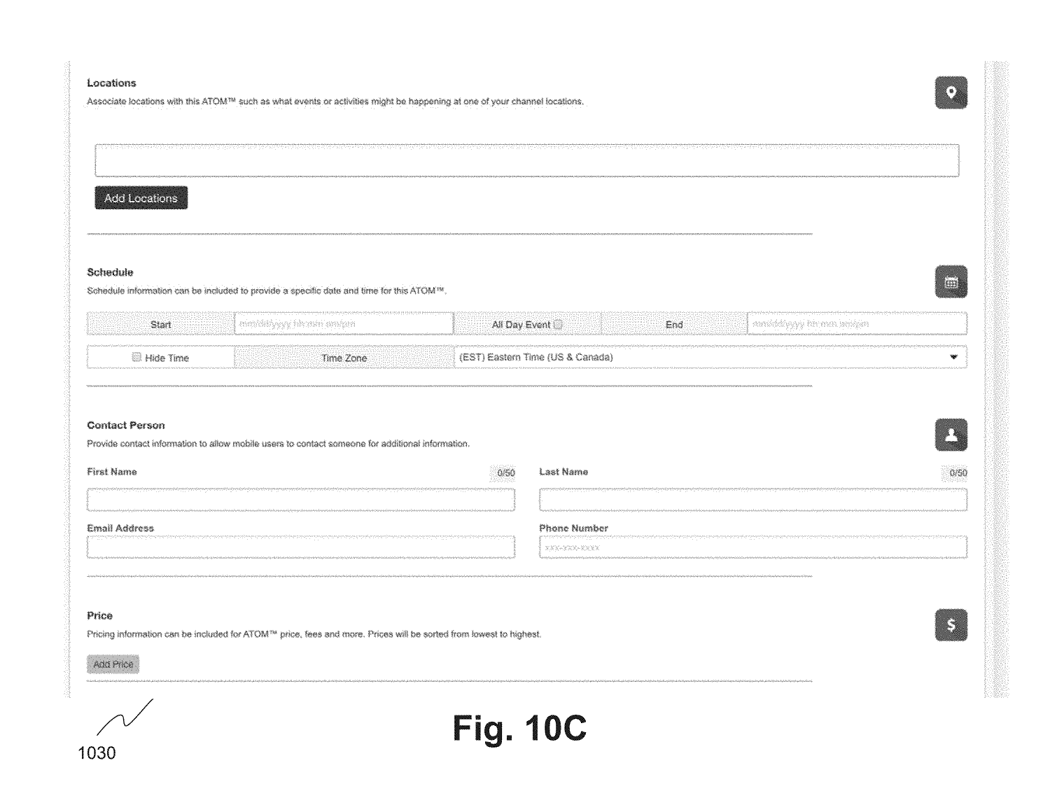

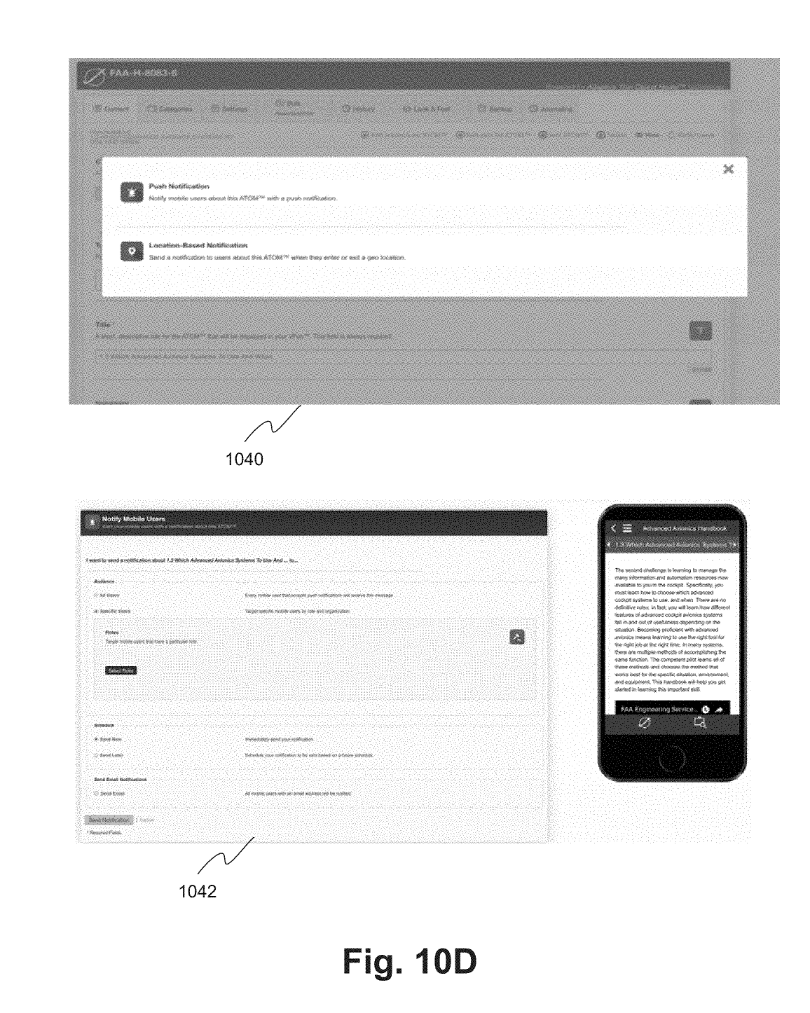

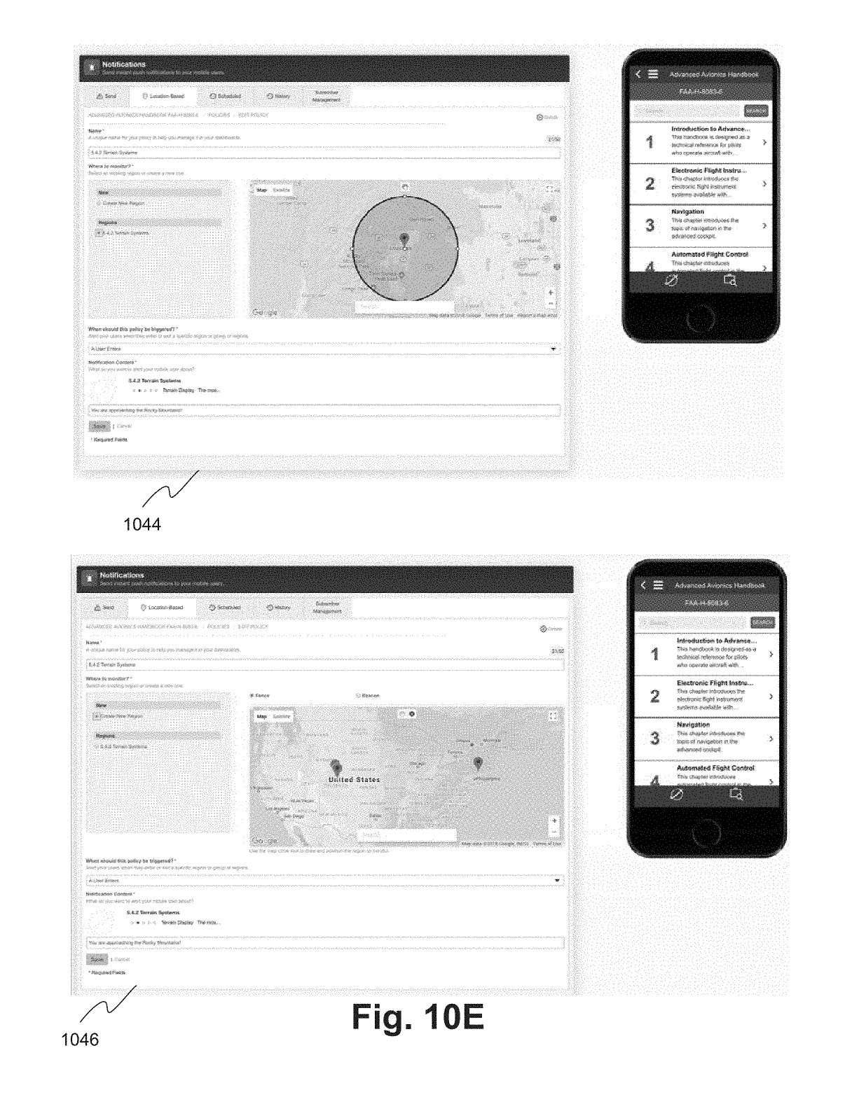

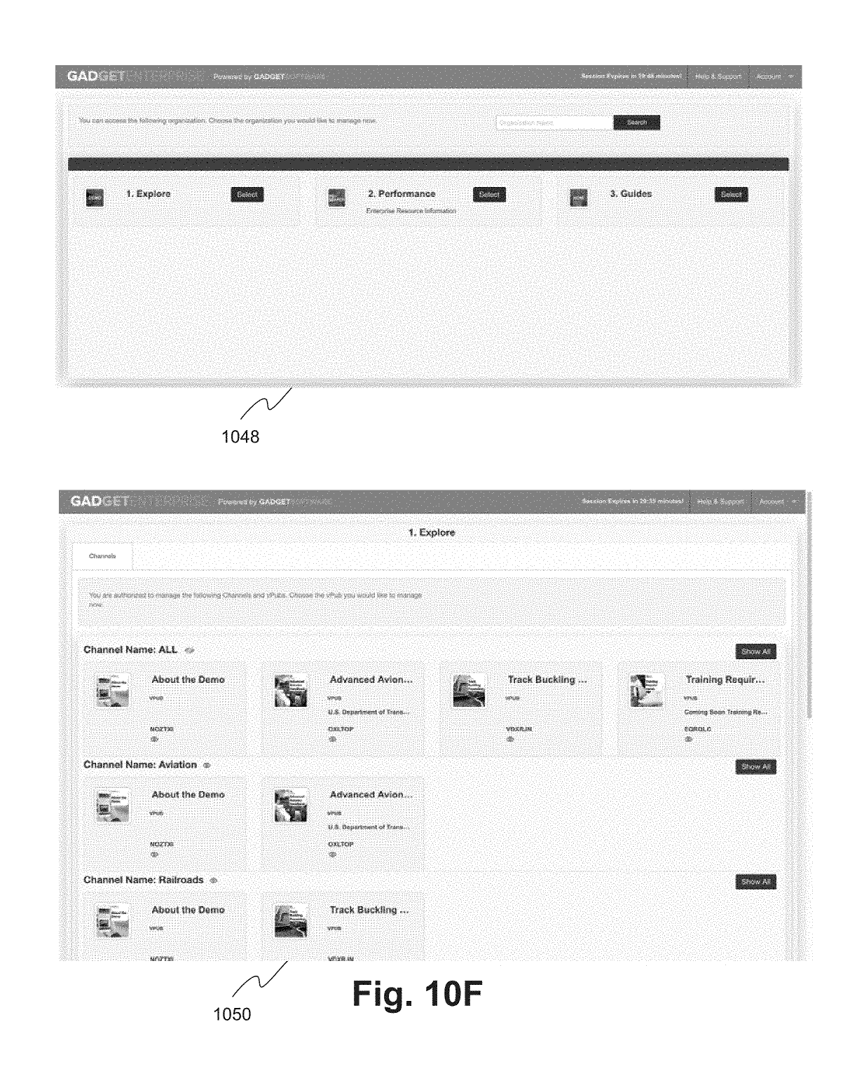

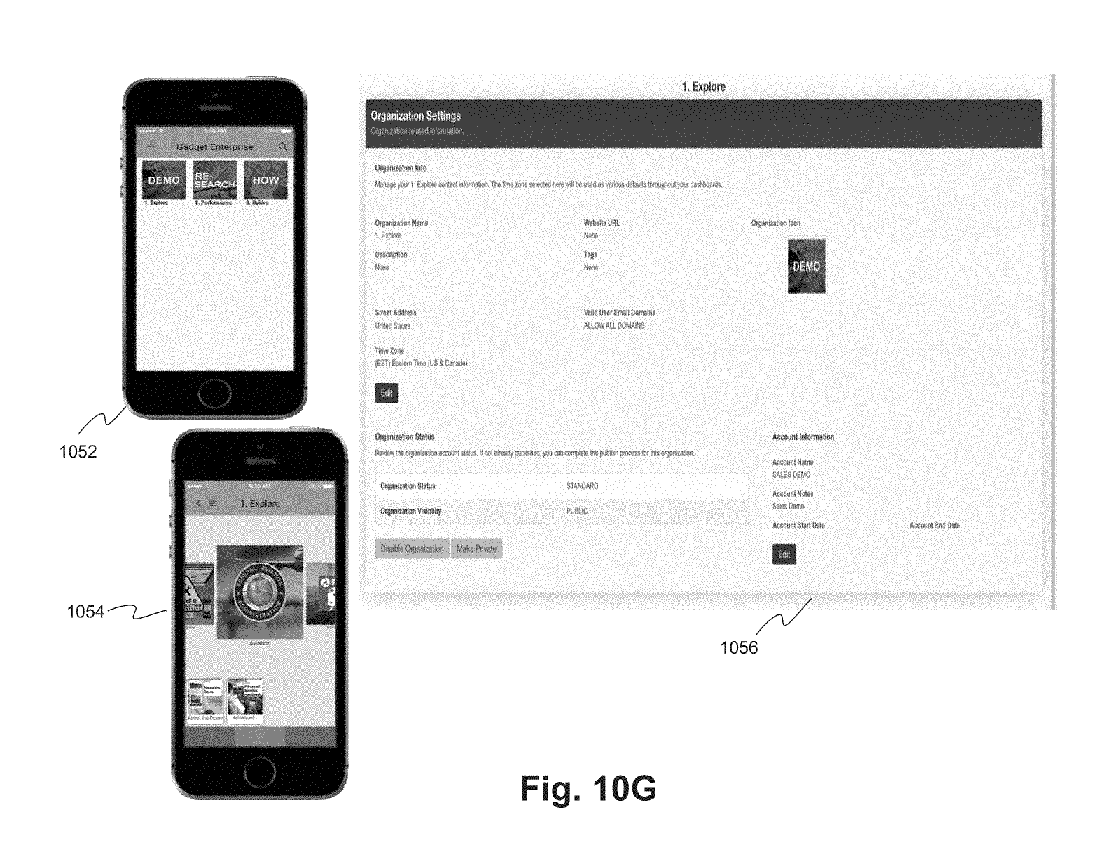

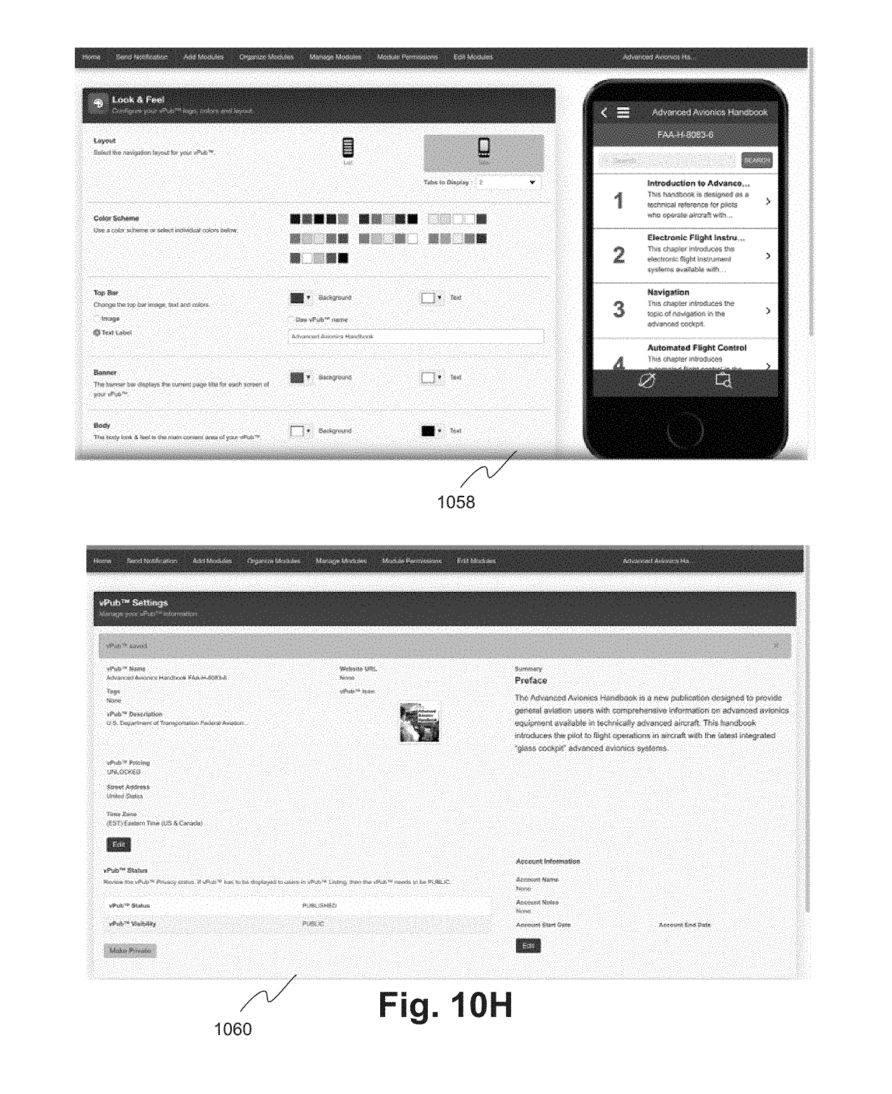

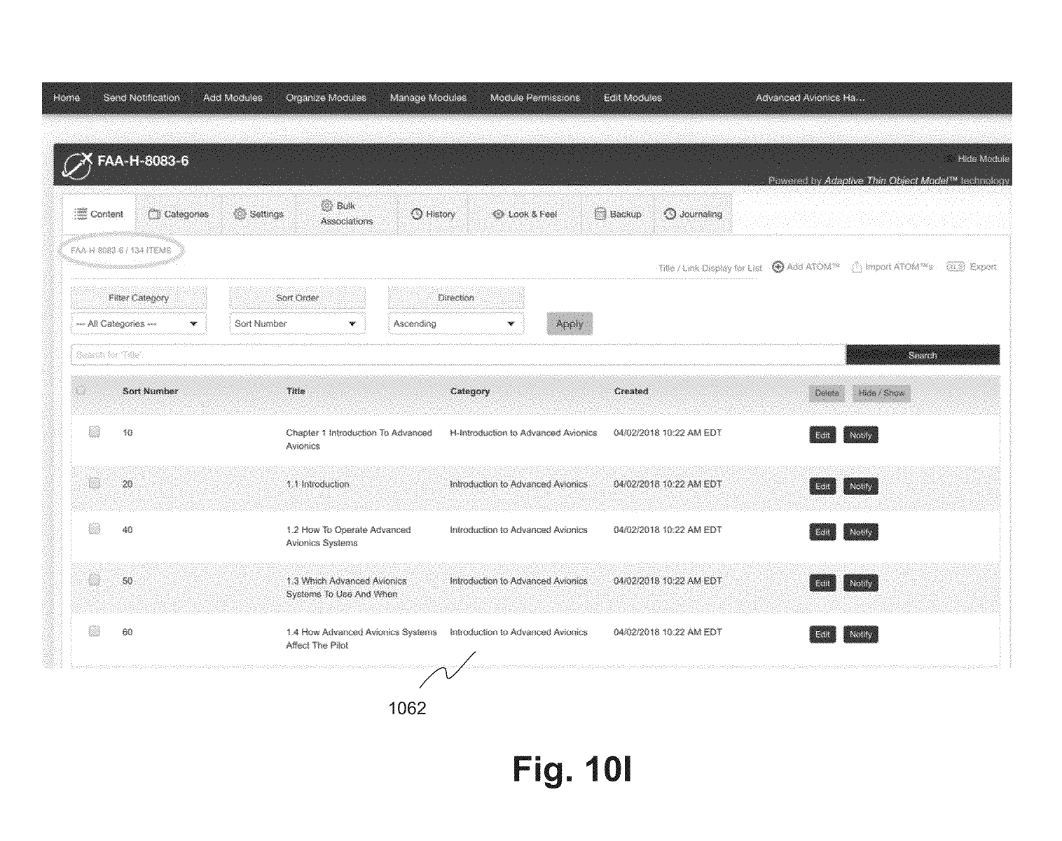

FIGS. 10A, 10B, 10C, 10D, 10E, 10F, 10G, 10H and 10I illustrate an editing mode of an authoring tool on an adaptive thin object model record, according to an embodiment. Selecting an adaptive thin object model record such as adaptive thin object model record 912-1 in FIG. 9, allows adaptive thin object model record 912-1 to be edited. Editing screen 1010 in FIG. 10A shows the selection of the adaptive thin object model record associated with “1.3 Which Advanced Avionics Systems To Use And When” in which the contents can be added or modified. Specifically editing screen 1010 illustrates the editing of the search tag (not updated), title (modified), summary (not updated), sort number (modified) and image (not updated). Editing screen 1020 in FIG. 10B illustrates the editing of the description (modified in HTML), website URL (not updated), the RSS feed (not updated), categories (modified as provided by atomic reading structure module 440). Editing screen 1030 in FIG. 10C illustrates the editing of the map/location (added as provided by vPub container 420 and interpreted by LiveClient applications 410-1 to 410-N) date/schedule (not updated), contact person (not updated) and price (not updated). Editing screen 1040 in FIG. 10D illustrates the editing of notifications (added as provided by vPub container 420 and interpreted by LiveClient applications 410-1 to 410-N using time/date and geo-fence). A geo-fence is a virtual geographic boundary, defined by GPS or RFID technology, which enables software to trigger a response when a mobile device enters or leaves a particular area. Push-notification 1042 illustrates the ability to define a geo-fence where a notification is generated when a target leaves a certain area. Examples of such geo-fence areas are shown in Geofence 1044 and Geofence 1046 in FIG. 10E.

FIG. 10F illustrates various views of an authoring console and the LiveClient application. For example screenshot 1048 illustrates an authoring console view of virtual libraries that contain channels that organize virtual publication components by topics, subjects or themes. Screenshot 1050 illustrates an authoring console view of virtual publication components organized into virtual channels. View 1052 in FIG. 10G illustrates a LiveClient application view of virtual libraries that contain virtual channels that organize virtual publication components by topics, subject or themes. View 1054 in FIG. 10G illustrates a LiveClient application view of virtual publication components organized into virtual channels. Screenshot 1056 in FIG. 10G illustrates an authoring console where an author can change the state of a virtual library where each state is either enabled or disabled, and also determine if the library is public or private.

FIG. 10H illustrates further screenshots of various settings of the system. For example, screenshot 1058 illustrates an authoring console where an author can control the look and feel, e.g., color scheme, navigation options, etc., of a particular virtual publication. Screenshot 1060 illustrates the ability to control vPub setting including description, associated URL, a summary, status and ability to control public versus private viewing. Screenshot 1062 in FIG. 10I illustrates the ability to view and modify the contents of an adaptive thin object model record through the use of the atomic reading structure module, e.g., atomic reading structure module 440. FIG. 10I also indicates the total number of adaptive thin object model records contained within the atomic reading structure.

Attaching data elements, supplemental elements and service elements to an adaptive thin object model record increases its multimedia density. Data element data is stored and managed within each adaptive thin object model record. Service elements are attached to adaptive thin object model records. Service elements connect adaptive thin object model records to external internet and extranet resources such as maps, geo-fences, Rich Site Summary (“RSS”) feeds, external websites and other data sources. Service elements are managed by non-adaptive thin object model record entities managed by the atomic reading structure module 440, vPub container 420 or an Internet resource. Service elements are provided by the atomic reading structure module 440, vPub container 420 or an Internet or an Extranet resource such as webpage, data feed or data source.

Atomic reading structure module 440 manages template settings that determine which supplemental elements are available to adaptive thin object model records. Atomic reading structure module 440 also configures category service element assignment that determines where an adaptive thin object model record appears within atomic reading structure module 440, activates swipe navigation and determines the sort order of adaptive thin object model records. Atomic reading structure module 440 operates in three states—visible, hidden and off. Atomic reading structure module 440 also controls the importation of data elements and the exportation and backup of atomized content. Further, adaptive thin object model records can be created individually or bulk loaded.

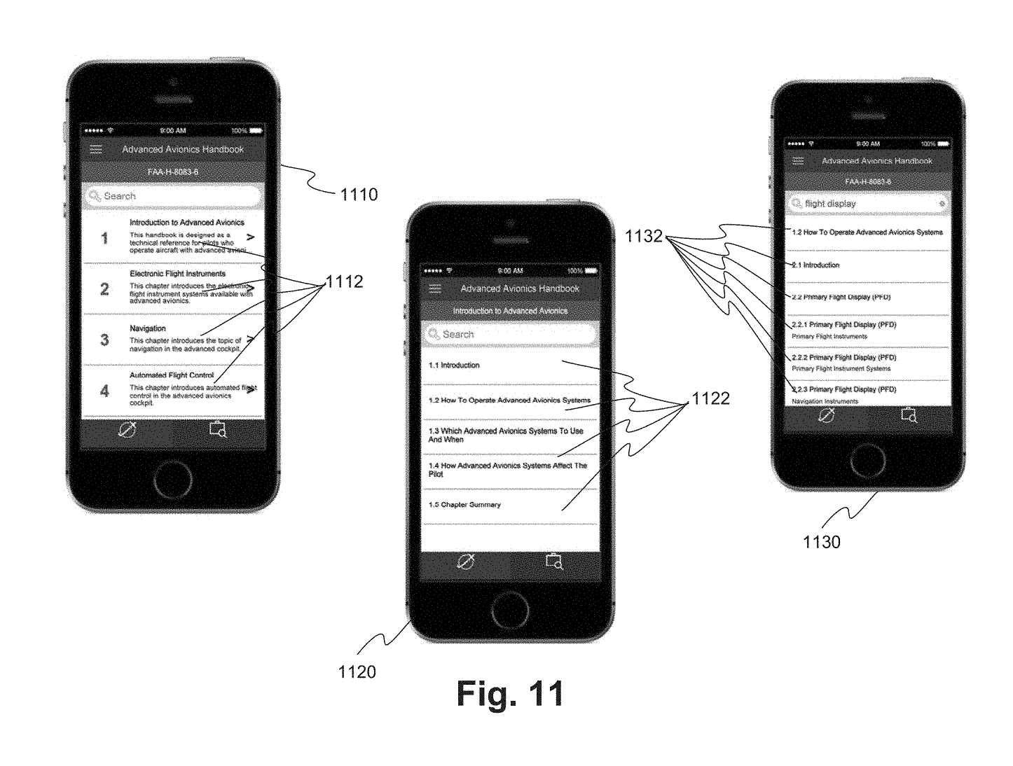

FIG. 11 illustrates delivery of adaptive thin object model records through a client to a mobile device, according to an embodiment. Atomic reading structure module 440 management of adaptive thin object model records 450-1 to 450-N are presented within vPub container 420 and delivered through LiveClient applications 410-1 to 410-N. LiveClient applications 410-1 to 410-N interpret vPub container 420 instructions, service requests and presents the adaptive thin object model records 450-1 to 450-N. LiveClient applications 410-1 to 410-N display the adaptive thin object model records 450-1 to 450-N in two modes and accepts the adaptive thin object model records 450-1 to 450-N specific notifications and broader vPub container 420 notifications.

Mobile device 1110, using a default mode (Flash) presents a list of visible categories 1112 and adaptive thin object model records 1122 (on mobile device 1120) in the defined sort order. In Flash mode, categories and adaptive thin object model records 1122 display Title (required) and optional Image or Summary data. Users can select a category (Category) and choose adaptive thin object model records 1122 (Section) to view; or use search to reveal all adaptive thin object model records 1132 (on mobile device 1130) containing that word or phrase (e.g., flight display).

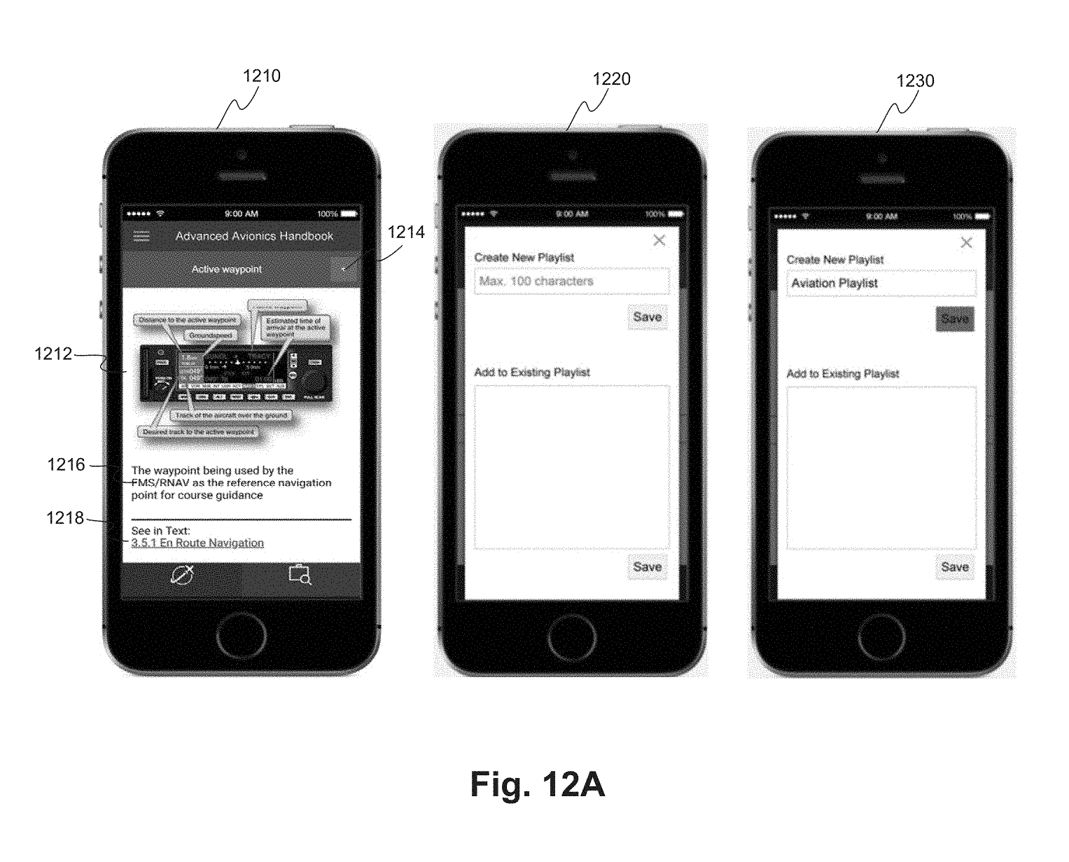

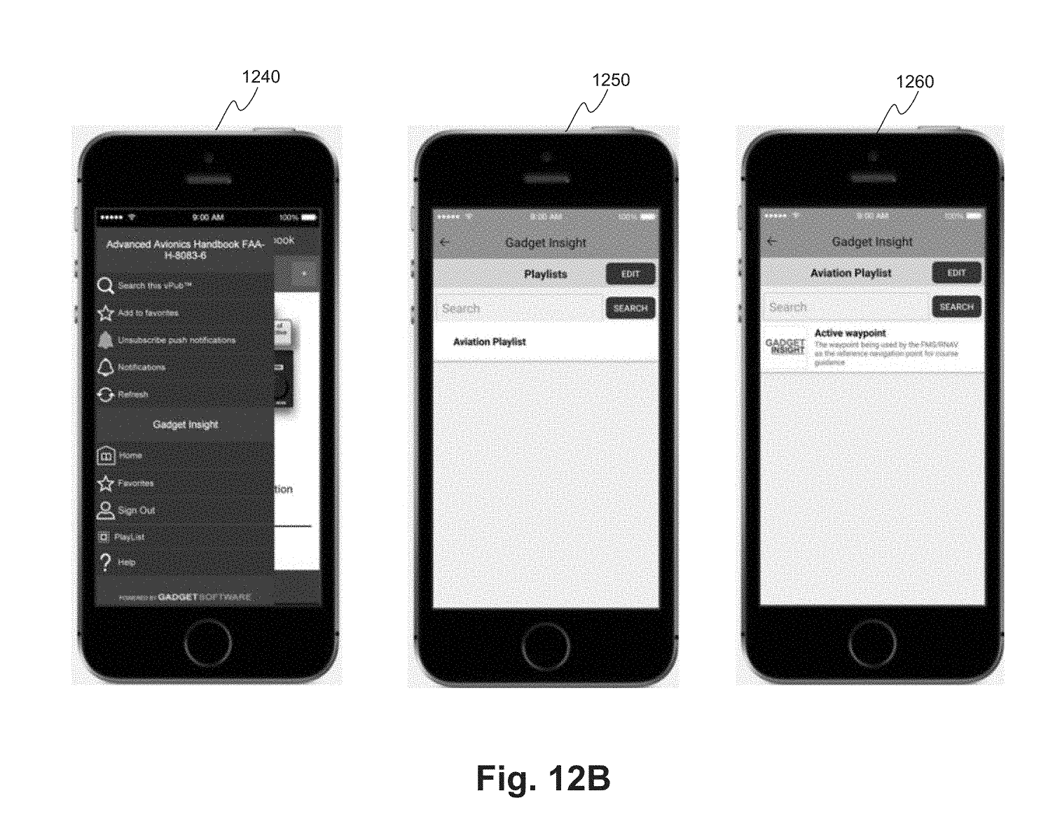

FIG. 12A depicts a focus mode of a selected adaptive thin object model record, according to an embodiment. Selecting a specific adaptive thin object model record activates Focus mode. Focus mode exposes its data element, supplemental elements and service elements. When the atomic reading structure module 440 swipe navigation feature is active, LiveClient applications 410-1 to 410-N enable touch-based swiping based on the sort sequence. Thus, for example, mobile device 1210 displays a vPub container image presenting an adaptive thin object model record 1212 that includes a supplemental element playlist+link 1214, a data element image of FMS/RNAV 1216 and a data element text and hyperlink 1218 to another adaptive thin object model record while stored within a separate atomic reading structure module.

Regarding playlists, a user can add an adaptive thin object model record to a playlist by selecting the playlist link+1214. A user can also create a new playlist and save or add to an existing playlist as shown in view 1220. View 1230 illustrates an example of a user creating a new playlist titled “Aviation Playlist.” View 1240 of FIG. 12B illustrates how a user can access LiveClient playlists from a LiveClient menu. View 1250 illustrates how a user can view a list of playlists. And, view 1260 illustrates how a user can view adaptive thin object model records. Further, playlists, such as playlist 412 can be accessed directly from LiveClient applications 410-1 to 410-N without the need to access vPub container 420.

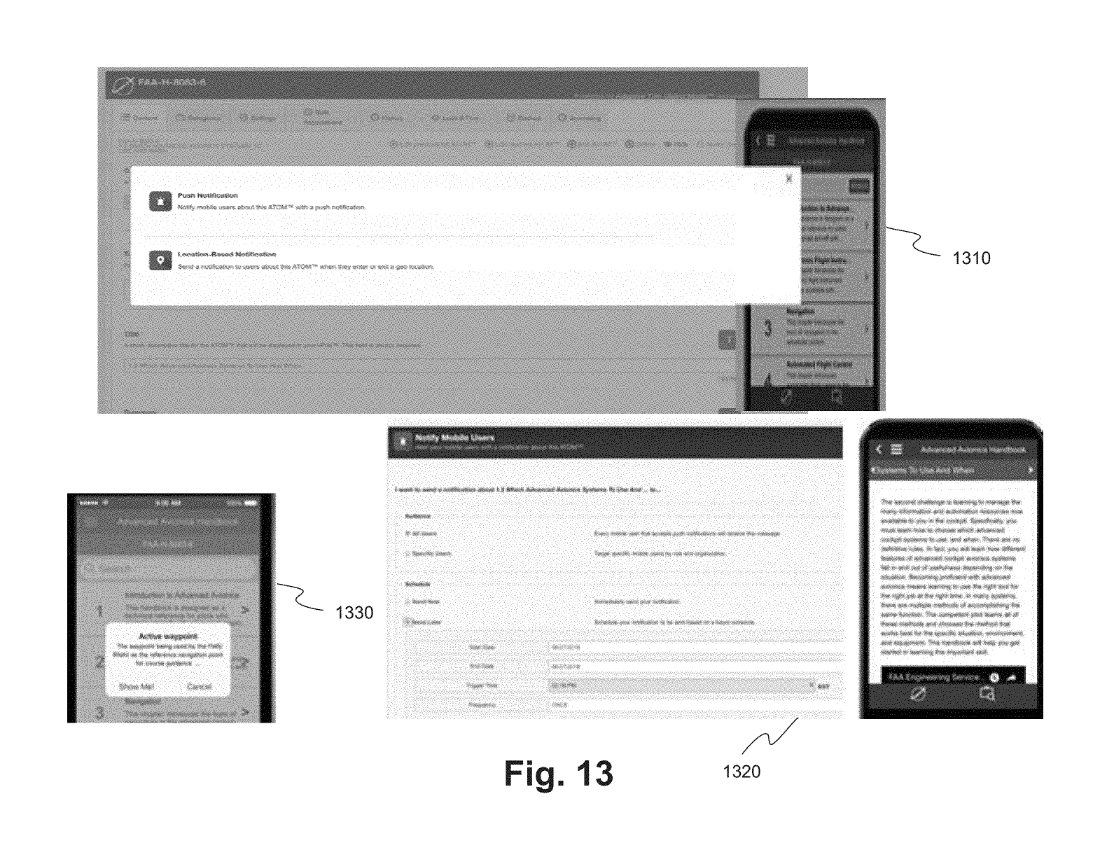

FIG. 13 depicts the use of a notification service with a unit of text delivered to a mobile device, according to an embodiment. Editing screen 1310 illustrates the editing of notification. Push-notification 1320 illustrates the ability to define a date specific notification where a notification is generated when a date is reached. Mobile device 1330 shows receipt of a service element that is a notification that is triggered when the date specific notification service element was attached to the corresponding adaptive thin object model record.

The playlist function enables mobile users to select, add and save one or more adaptive thin object model records from one or more vPub containers, e.g., vPub container 420, through the LiveClient application, e.g., LiveClient application 410-1. Saving an adaptive thin object model record creates a pointer to the adaptive thin object model record. Mobile users can save adaptive thin object model records from one or more vPub containers to a playlist, or a collection of adaptive thin object model records, organized by topic, subject, theme, etc. In an embodiment, adaptive thin object model records can only be saved to a playlist while the mobile user is online.

Playlists are collections of pointers back to their respective adaptive thin object model records. Launching the playlist streams the collection of pointers associated with the adaptive thin object model records. Playlists can be renamed and further personalized changing the order in which adaptive thin object model records appear. The adaptive thin object model records in a playlist can be navigated from one to another via swipe.

Playlists can be locally stored on a mobile device for online and offline access. If the source adaptive thin object model record is changed while online, the pointer found in the playlist will be updated to reflect the changes made. If the source adaptive thin object model record is changed in any way while offline, the pointer found in the playlist will only be updated to reflect the changes made when the mobile user is back online. If the source adaptive thin object model record saved to a playlist is removed from the vPub container, a mobile user will receive an alert, when back online, stating the adaptive thin object model record has been removed from the playlist.

### Methods

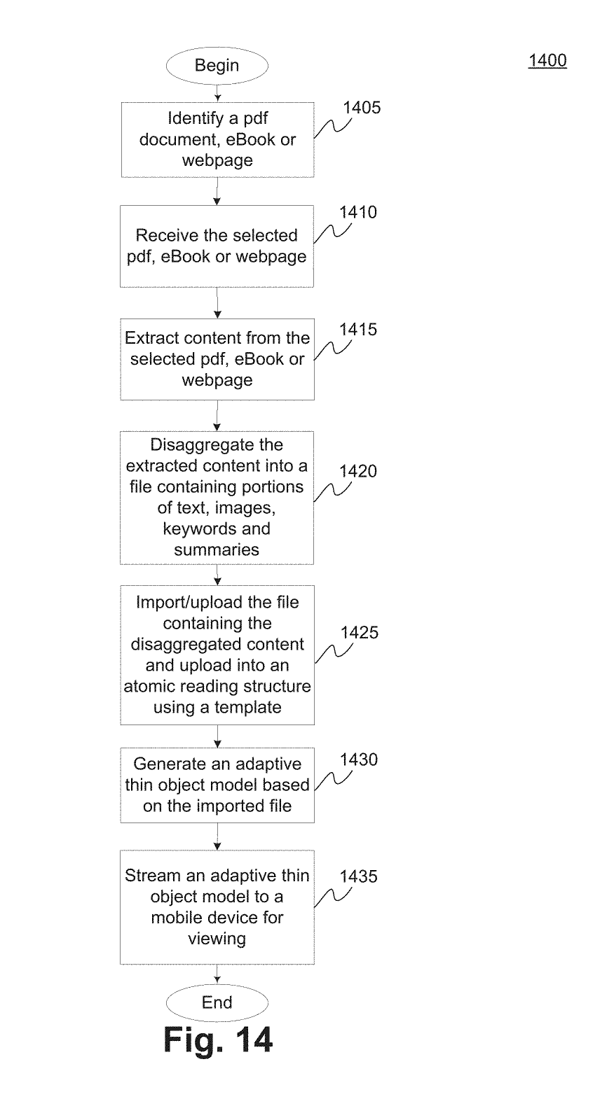

FIG. 14 shows an exemplary embodiment of a method 1400 for atomizing digital content into multi-media objects and then streams the contents to a mobile device, according to an embodiment. Method 1400 begins at step 1405 where reading content is identified. Such content can exist in a variety of forms, including a pdf document, eBook or webpage. The content is known as dense, page-oriented content that was targeted for digital readers and browsers and primarily designed to leverage large, wide screens. Such content is not suitable for display with mobile devices such as smartphones that feature small narrow screens that are designed to display thin message-oriented content.

Since the use of smartphone adoption by the world's population is expected to surpass 80% by 2020, this new communication landscape requires a new content structure and delivery model for dense information. Thus, dense, page-oriented content requires atomization into small discoverable units that can be updated and streamed in real-time. This process begins, as stated in step 1405 where the content to be atomized is identified.

At step 1410 the selected content such as a pdf document, eBook or webpage is received. As discussed in FIG. 5, readable content, or dense content, is stored in server 550. Such content can be stored in any type of computational device or storage device, such as a thumb drive, optical storage, or the like. Content can be retrieved from any source and can include the use of the Internet or any other type of communication including a local or wide area network. In another embodiment, the content can be stored in other devices other than server 550, such storage could include mobile device 110 and memory 130. In another embodiment, such storage and processing can take place in the cloud as part of a cloud computing solution.

At step 1415 content is extracted from the selected material, e.g., the pdf, eBook or website. Extraction of the content can be done manually, via software, or by creating an adaptive thin object model record and by adding content manually.

At step 1420 the extracted content is then disaggregated, or sub-divided into units. As discussed in with reference to FIG. 6, disaggregated data elements 615-1 to 615-3 are generated by server 550 and atomic reading structure module 610 through the application of a template. In an embodiment, a template is applied to the units of text stored across pages of the pdf, eBook or HTML webpage. In an example case each unit (description), first 145 characters (summary), assigned object label (title), ordering value (sort number), and list assignment (category) is extracted, or disaggregated, from the dense content.

At step 1425 the file containing the disaggregated content is imported or uploaded using a template. In an embodiment, the file is imported or uploaded to server 550. The importation process involves the use of a predefined template where the template determines which supplemental elements and service elements are to be available to each adaptive thin object model record. Data elements can include text, video, audio, etc., while service elements refer to internet or extranet services such as a location or notification or data feeds.

At step 1430 an adaptive thin object model record is generated based on the imported file. As discussed with reference to FIG. 9, each adaptive thin object model record 912-1 to 912-3 represents a unit of related text extracted from the document plus title, summary, sort number and assigned categories. Each adaptive thin object model record 912 contains more content than the original unit making the aggregate size of the adaptive thin object model record 912-1 to 912-3 larger than the original publication.

At step 1435, the adaptive thin object model records generated in step 1430 are streamed to a mobile device for viewing. As discussed regarding FIG. 11, atomic reading structure module 440 management of adaptive thin object model records 450-1 to 450-N are presented within vPub container 420 and delivered through LiveClient applications 410-1 to 410-N. LiveClient applications 410-1 to 410-N interpret vPub container 420 instructions, service requests and presents the adaptive thin object model records 450-1 to 450-N. LiveClient applications 410-1 to 410-N display the adaptive thin object model records 450-1 to 450-N in two modes and accepts the adaptive thin object model records 450-1 to 450-N specific notifications and broader vPub container 420 notifications.

Method 1400 then ends.

### Example Computer System Implementation

Aspects of the present invention shown in FIGS. 1-14, or any part(s) or function(s) thereof, may be implemented using hardware, software modules, firmware, tangible computer readable media having instructions stored thereon, or a combination thereof and may be implemented in one or more computer systems or other processing systems.

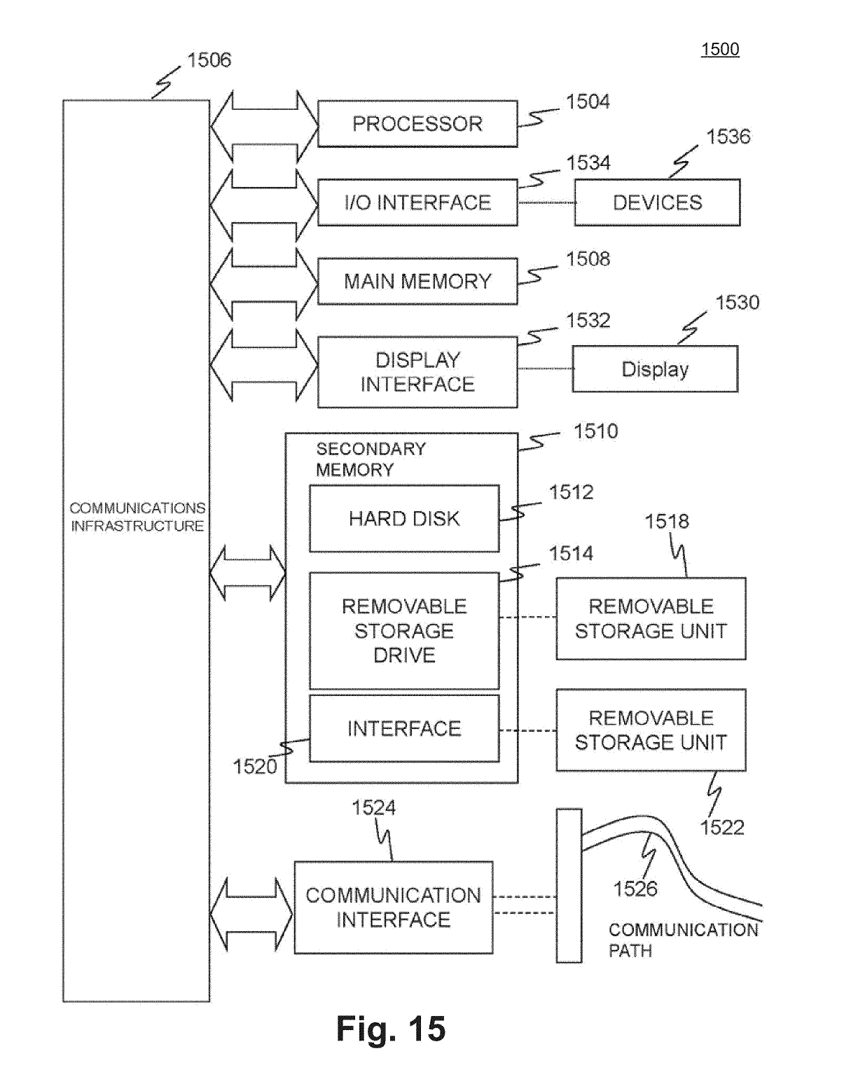

FIG. 15 illustrates a computer system 1500 in which embodiments, or portions thereof, may be implemented as computer-readable code. For example, portions of system 400 may be implemented in portions of computer system 1500 using hardware, software, firmware, tangible computer readable media having instructions stored thereon, or a combination thereof and may be implemented in one or more server computer systems or other processing systems. Hardware, software, or any combination of such may embody any of the modules and components in FIGS. 1-6.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of computer system 1500. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1504 may be a special purpose or a general purpose processor device. As will be appreciated by persons skilled in the relevant art, processor device 1504 may also be a single processor in a multi-core/multiprocessor system, such system operating alone, or in a cluster of computing devices operating in a cluster or server farm. Processor device 1504 is connected to a communication infrastructure 1506, for example, a bus, message queue, network, or multi-core message-passing scheme.

Computer system 1500 also includes a main memory 1508, for example, random access memory (RAM), and may also include a secondary memory 1510. Secondary memory 1510 may include, for example, a hard disk drive 1512, removable storage drive 1514. Removable storage drive 1514 may include a floppy disk drive, a magnetic tape drive, an optical disk drive, a flash memory, or the like. The removable storage drive 1514 reads from and/or writes to a removable storage unit 1518 in a well-known manner. Removable storage unit 1518 may include a floppy disk, magnetic tape, optical disk, etc. which is read by and written to by removable storage drive 1514. As will be appreciated by persons skilled in the relevant art, removable storage unit 1518 includes a computer usable storage medium having stored therein computer software and/or data.

Computer system 1500 (optionally) includes a display interface 1532 (which can include input and output devices such as keyboards, mice, etc.) that forwards graphics, text, and other data from communication infrastructure 1506 (or from a frame buffer not shown) for display on display unit 1530. Computer system 1500 is not limited to a particular design and can be a microcontroller, microprocessor, System on integrated circuit (SOIC), application specific integrated circuit, any combination thereof.

In alternative implementations, secondary memory 1510 may include other similar means for allowing computer programs or other instructions to be loaded into computer system 1500. Such means may include, for example, a removable storage unit 1522 and an interface 1520. Examples of such means may include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to computer system 1500.

Computer system 1500 may also include a communication interface 1524.

Communication interface 1524 allows software and data to be transferred between computer system 1500 and external devices. Communication interface 1524 may include a modem, a network interface (such as an Ethernet card), a communication port, a PCMCIA slot and card, wireless communications including WiFi and cellular, or the like. Software and data transferred via communication interface 1524 may be in the form of signals, which may be electronic, electromagnetic, optical, or other signals capable of being received by communication interface 1524. These signals may be provided to communication interface 1524 via a communication path 1526. Communication path 1526 carries signals and may be implemented using wire or cable, fiber optics, a phone line, a cellular link, a WiFi link, or any other RF link or other communication channels.

In this document, the terms “computer program medium” and “computer usable medium” are used to generally refer to media such as removable storage unit 1518, removable storage unit 1522, and a hard disk installed in hard disk drive 1512. Computer program medium and computer usable medium may also refer to memories, such as main memory 1508 and secondary memory 1510, which may be memory semiconductors (e.g. DRAMs, etc.).

Computer programs (also called computer control logic) are stored in main memory 1508 and/or secondary memory 1510. Computer programs may also be received via communication interface 1524. Such computer programs, when executed, enable computer system 1500 to implement the present invention as discussed herein. In particular, the computer programs, when executed, enable processor device 1504 to implement the processes of the present invention, such as the stages in the methods illustrated by method 1400 of FIGS. 1-13, as previously discussed. Accordingly, such computer programs represent controllers of the computer system 1500. Where the invention is implemented using software, the software may be stored in a computer program product and loaded into computer system 1500 using removable storage drive 1514, interface 1520, and hard disk drive 1512, or communication interface 1524.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. An adaptive thin object model system comprising:
a server system configured to disaggregate content for delivery to a mobile device configured with a touch or hands-free interface;
an extraction system configured to receive dense content from a dense digital content publication and extract units of information from the dense content;
the extraction system further configured to disaggregate different types of content within the dense content into a plurality of identified data elements; and
an atomic reading structure module in which each of the plurality of identified data elements is assembled and each is stored as an adaptive thin object model record, wherein the server system is further configured to receive a request from the mobile device for delivery of one or more of the stored adaptive thin object model records.

2. The adaptive thin object model system of claim 1, wherein the dense digital content publication is in a portable document format (pdf), an electronic book (eBook) format or a webpage.

3. The adaptive thin object model system of claim 1, further comprising delivery of a stored adaptive thin object model record to the mobile device.

4. The adaptive thin object model system of claim 1, wherein each of the plurality of identified data elements assembled and stored as adaptive thin object model records include a description, a summary, a title, an ordering value and a category assignment.

5. The adaptive thin object model system of claim 1, wherein the dense digital content publication contains pages that are sequential paragraphs, chapters, or sections and where the stored adaptive thin object model records generated from the dense digital content publication exist as non-linear records.

6. The adaptive thin object model system of claim 1, wherein a user selects a non-linear sequence of content to be viewed by the user.

7. The adaptive thin object model system of claim 1, further comprising the atomic reading structure module configured to increase content density by adding data elements and service elements to an adaptive thin object model record.

8. The adaptive thin object model system of claim 7, wherein the data elements comprise a text or a video or an audio and the service elements comprise a location or a notification.

9. The adaptive thin object model system of claim 1, wherein each of the one or more of the stored adaptive thin object model records can be edited independently and ordered and associated with multiple groups, searched, linked and saved.

10. The adaptive thin object model system of claim 1, further comprising a LiveClient application on the mobile device configured to control access and segment a plurality of virtual publications by a library and categorize by a virtual channel.

11. The adaptive thin object model system of claim 10, wherein the virtual channel categorizes a virtual publication by a topic, a subject or a theme.

12. A method for disaggregating dense content using an adaptive thin object model, the method comprising:
receiving dense content from a dense digital content publication;
converting the dense content to a hypertext markup language (HTML);
disaggregating the dense content in the hypertext markup language into a plurality of units to remove a structure of the dense content with only data content comprising words, images and media representing one or more ideas remaining, wherein the disaggregating comprises removing any inline styles, classes, identifiers, comments and metadata unrelated to visible text and media;
analyzing the plurality of units comprising remaining text and styling elements to identify one or more unit boundaries for each of the plurality of units, wherein each of plurality of units represent an idea block;
inserting a unit marker above each idea block and saving each as a data element file; and
inserting into each data element file a title, a summary, a sort value and an identifying attribute.

13. The method of claim 12, further comprising concatenating each data element file and saving in a data element worksheet or in a section in a data element extensible markup language (XML) file.

14. A method of generating an adaptive thin object model, the method comprising:
receiving dense content from a dense digital content publication;
extracting units of information from the dense content;
disaggregating different types of content within the dense content into a plurality of identified data elements;
assembling and storing each of the plurality of identified data elements as an adaptive thin object model record; and
receiving a request from a mobile device for delivery of one or more of the stored adaptive thin object model records.

15. The method of claim 14, further comprising delivering one or more stored adaptive thin object model records to the mobile device.

16. The method of claim 14, further comprising storing a description, a summary, a title, an ordering value and a category assignment into each adaptive thin object model record.

17. The method of claim 14, further comprising selecting, by a user, a non-linear sequence of content to be viewed by the user.

18. The method of claim 14, further comprising increasing content density by adding data elements and service elements to one of the adaptive thin object model records.

19. The method of claim 18, wherein the data elements comprise a text or a video or an audio and the service elements comprise a location or a notification.

20. The method of claim 14, wherein each of the one or more of the stored adaptive thin object model records can be edited independently and ordered and associated with multiple groups, searched, linked and saved.
